(19) United States
(12) Patent Application Publication
(10) Pub. No.: US 2013/0091222 A1
(43) Pub. Date: Apr. 11, 2013

(54) MODEL-BASED CHARACTERIZATION OF INFORMATION PROPAGATION TIME BEHAVIOR IN A SOCIAL NETWORK

(71) Applicant: Vladimir Brayman, Mercer Island, WA (US)

(72) Inventor: Vladimir Brayman, Mercer Island, WA (US)

(73) Assignee: WEBTRENDS INC., Portland, WA (US)

(21) Appl. No.: 13/646,624

(22) Filed: Oct. 5, 2012

Related U.S. Application Data
(60) Provisional application No. 61/543,737, filed on Oct. 5, 2011.

(51) Int. Cl. H04L 12/58

(52) U.S. Cl. CPC H04L 51/32
USPC 709/204

(57) ABSTRACT

The current application is directed to methods and systems that accumulate data with respect to the time behavior of posts related to one or more pages of an individual or organization within a social network and generate one or more models that characterize the time behavior of posts within the social network. These models, or heuristics based on these models, can be used to estimate characteristics and parameters of the time behaviors of individual posts prior to posting or at various times following posting of the posts to social-network pages.

### CROSS-REFERENCE TO RELATED APPLICATION

This application claims the benefit of Provisional Application No. 61/543,737, filed Oct. 5, 2011.

### TECHNICAL FIELD

The current application is directed to methods and systems for estimating the time behavior of posts in a social network and, in particular, a method and system for accumulating data, over time, with regard to posts and pages, generating post-propagation models from the accumulated data, and using the post-propagation models to estimate various characteristics and parameters of the time behavior of individual posts.

### BACKGROUND

Social networking has blossomed, over the past decade, into a widely used and pervasive electronic communications medium through which individuals and organization exchange data, discover one another, monitor the activities of other individuals and organizations, advertise products and services, search for products and services, and carry out a variety of other such activities based on the network of links between individuals and organizations and data made accessible about individuals and organizations through the various different social networks. Recently, the Facebook social network announced that one billion individuals and organizations currently participate in the Facebook® social network, which represents an enormous potential audience for dissemination of information, including various types of advertising.

There are various models by which information reaches a participant in a social network. In one model, participants actively search for information by various searching methods and pulling the information from various nodes of the social network. In another model, social-network participants receive posts automatically, depending on their linkage to social-network pages, other social-network participants, and various types of interest-expression events within a sub-network that includes the social-network participants receiving the post. In yet an additional model for information dissemination within a social network, a social-network participant pays a fee to distribute information to selected social-network participants.

Post-based information dissemination is attractive to advertisers and marketeers because it enables advertisers and marketers to reach a potentially large audience at minimal cost. However, advertisers and marketers have few criteria, currently, by which they can carry out post-based advertising effectively in social networks. For this reason, advertisers, marketeers, and various different organizations and individuals all seek methods and criteria for employing post-based information dissemination effectively in distributing information within social networks.

### SUMMARY

The current application is directed to methods and systems that accumulate data with respect to the time behavior of posts related to one or more pages of an individual or organization within a social network and generate one or more models that characterize the time behavior of posts within the social network. These models, or heuristics based on these models, can be used to estimate characteristics and parameters of the time behaviors of individual posts prior to posting or at various times following posting of the posts to social-network pages.

### BRIEF DESCRIPTION OF THE DRAWINGS

FIG. 1 illustrates a hardware and electronic-communications-network context in which one implementation of the model-based method for estimating the time behavior of posts of social networks can be applied.

FIG. 2 shows a generalized computer architecture for various computing appliances used to implement social networks and to access social networks.

FIG. 3 shows a higher-level view of the hardware and electronics-communications-network context shown in FIG. 1.

FIG. 4 illustrates the context shown in alternative manners in FIGS. 1 and 3 in yet a different manner.

FIG. 5 illustrates the concept of direct links to a social-network page.

FIG. 6 illustrates, in graphical form, the accretion of direct links to an organization's social-network page over time.

FIGS. 7A-F illustrate post propagation in a social network.

FIGS. 8A-E illustrate advertising via posts within a social network.

FIGS. 9A-C illustrate models used by the currently disclosed methods and systems for estimating characteristics and parameters of post propagation in a social network.

FIG. 10 illustrates certain of the attributes that may be associated with pages and posts.

FIG. 11 illustrates a period of time in which an advertiser may be most interested in characterizing the time behavior of post propagation.

FIGS. 12A-E illustrate resolution of collected data into data subsets for which accurate predictive models can be estimated.

FIGS. 13A-C illustrate computing a fitness metric for a particular model with respect to a collection of data points.

FIG. 14 illustrates a compactness metric that may be used to, at least in part, decide whether the distribution of a set of data points in a y(t) versus t plot is conducive for model fitting.

FIG. 15 illustrates attributes associated with social networks.

FIGS. 16A-H provide control-flow diagrams and one additional illustration that together describe a method for monitoring post-propagation time-dependent behavior and characteristics in a social network, determining attribute-associated models for post-propagation in a social network, and provide pre-posting and post-posting estimates of the propagation characteristics and parameters for a post based on attributes associated with the post, the page on which the post is made, and the social network.

### DETAILED DESCRIPTION

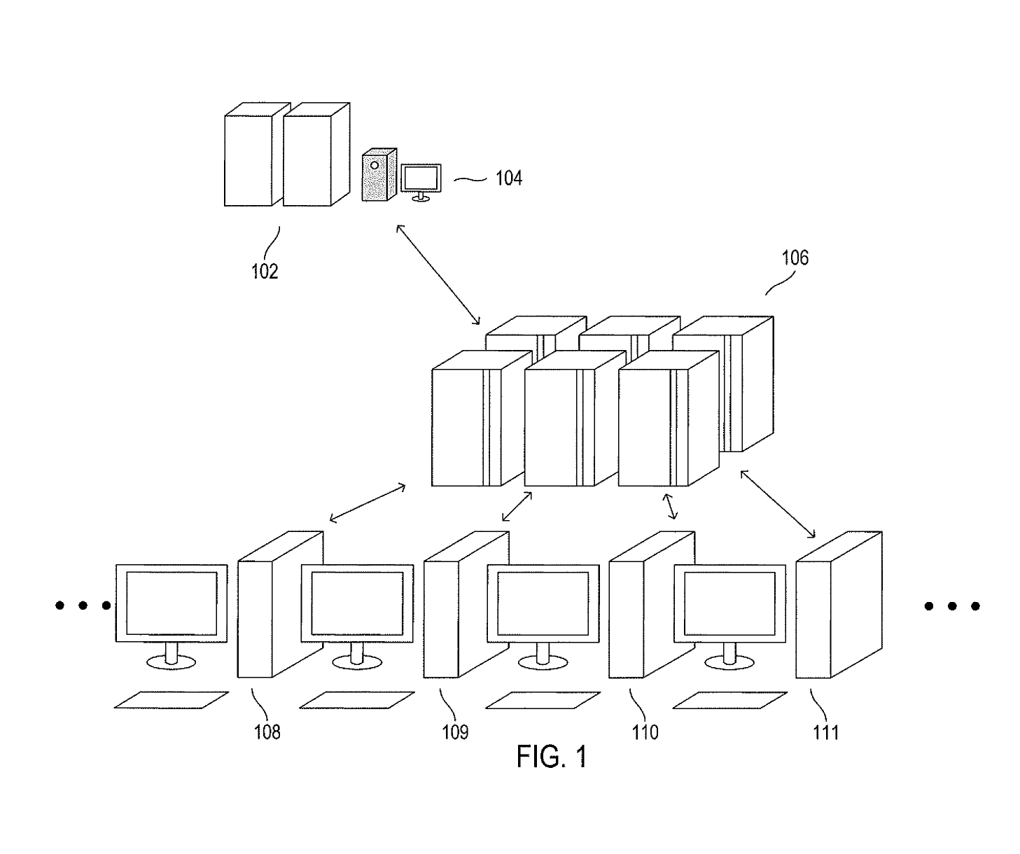

FIG. 1 illustrates a hardware and electronic-communications-network context in which one implementation of the model-based method for estimating the time behavior of posts of social networks can be applied. In this context, an organization, represented by an organization data center 102 and PC or work station 104 is linked to a social network, represented by a large data center 106 in which multiple additional social-network participants, each represented by a personal computer 108-111, participate. In general, both the organization and the other social-network participants are connected to the social network via the Internet by a variety of different types of electronic communications media and technologies. Participants may access the social network through any of many different types of stationary and mobile computing appliances, including PCs, mobile phones, tablets, and other types of computing appliances. A social network may include hundreds, thousands, millions, or more participants, including individuals, small organizations, and large organizations.

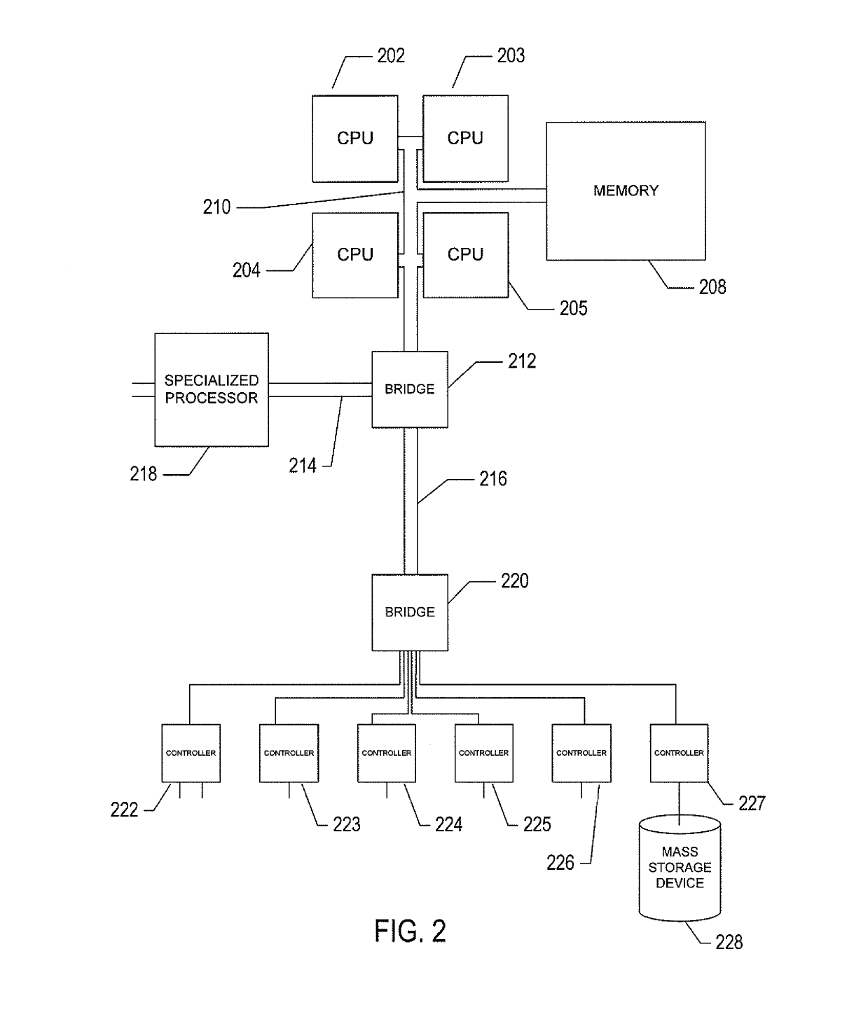

FIG. 2 shows a generalized computer architecture for various computing appliances used to implement social networks and to access social networks. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of mass-storage devices 228, electronic displays, input devices, and other such components, subcomponents, and computational resources. Computer-readable media include physical data-storage devices, such as electronic memories, mass-storage devices, and removable physical media, including optical disks. As those with understanding of modern science and technology understand, data cannot be stored in propagating electromagnetic radiation.

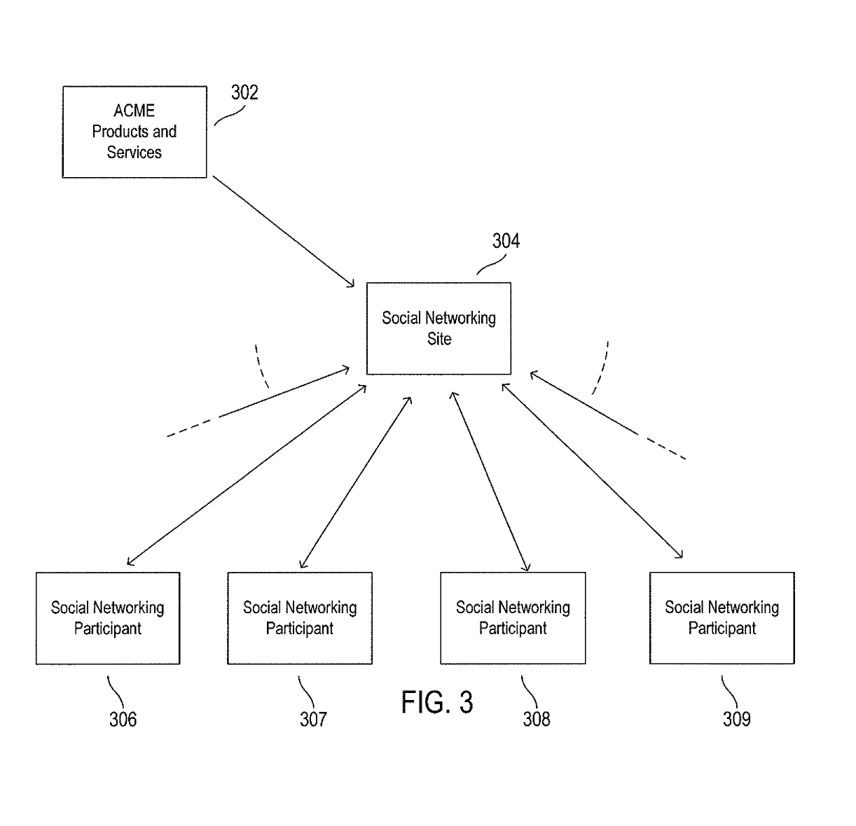

FIG. 3 shows a higher-level view of the hardware and electronics-communications-network context shown in FIG. 1. This higher-level context includes the organization 302, the social-network site 304, and various social-network participants 306-309. In the context shown in FIG. 3, described further below, the organization 302 posts one or more posts on social-network pages associated with the organization in order that the posts are received by social-network participants.

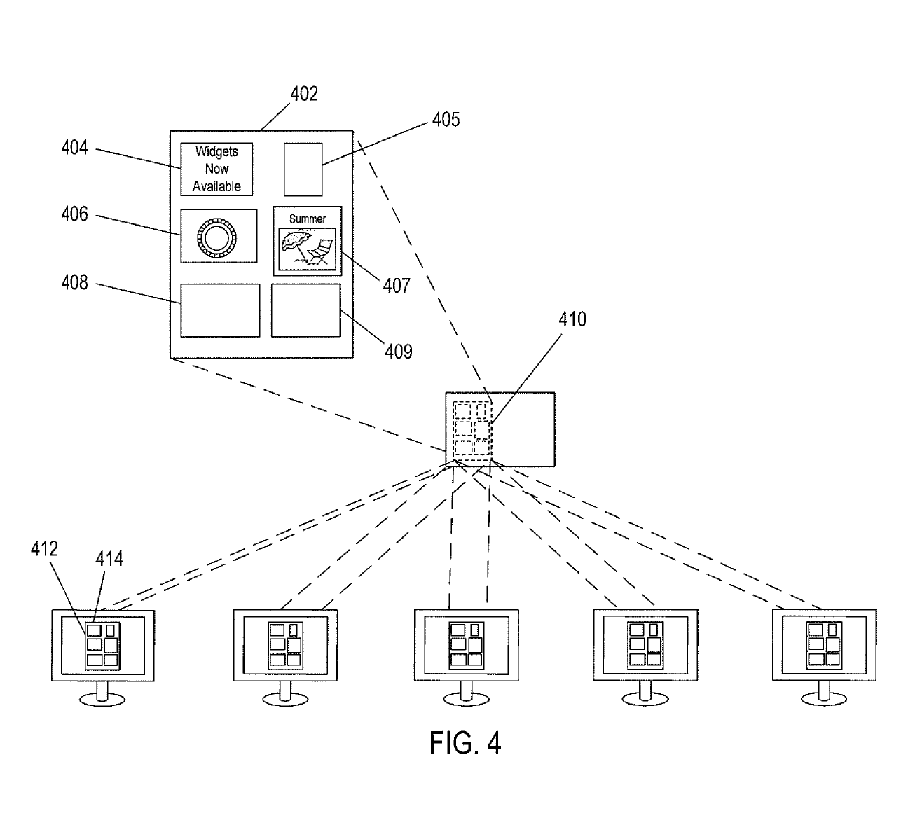

FIG. 4 illustrates the context shown in alternative manners in FIGS. 1 and 3 in yet a different manner. In FIG. 4, a social-network page 402 associated with the organization (302 in FIG. 3) is shown, the page 402 including a number of individual posts 404-409. Each post represents a small portion of the real estate of the page and contains various different types of information, including text, photos, videos, animations, and other types of information. Although the social-network page 402 is associated with the organization, the social-network page is electronically stored 410 within the social-network site (304 in FIG. 3), which distributes individuals posts or the entire page to various social-network participants, as indicated by the appearance of the page in each of the display screens representing social-network participants, including display page 412 within display screen 414. It should be noted that, in certain social networks, the social-network page may be another type of forum or collection with which posts are associated, and, in certain types of organizations, posts may be directly associated with organizations, without the need for an intermediary page or forum.

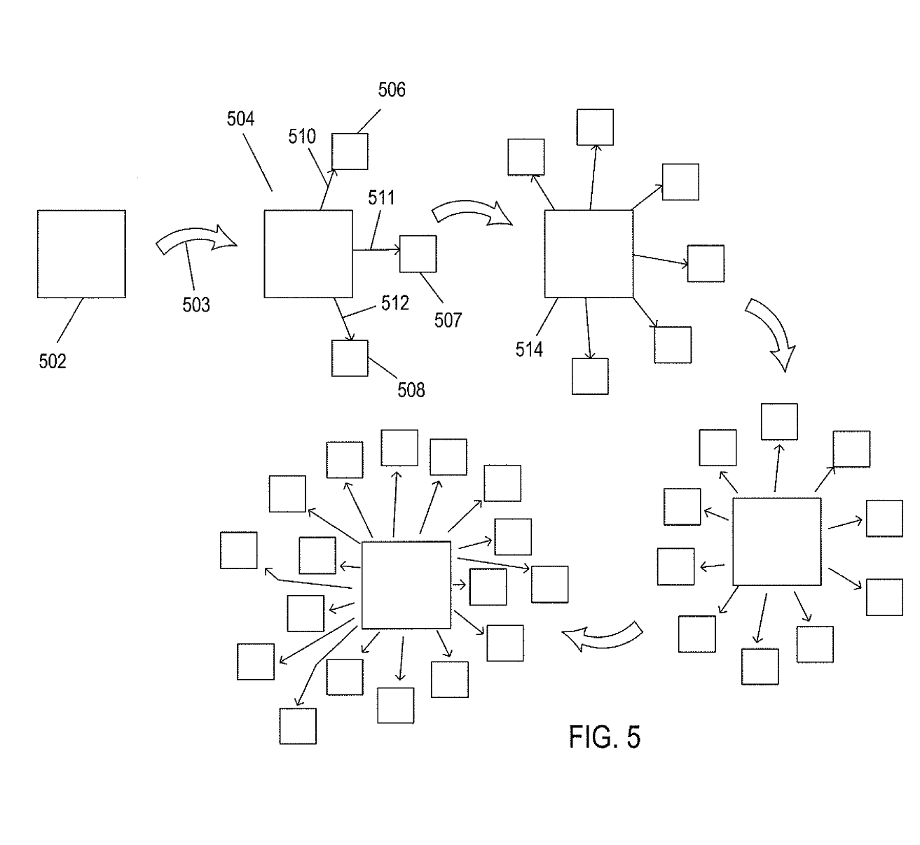

FIG. 5 illustrates the concept of direct links to a social-network page. In FIG. 5, the page associated with the organization is represented by a large rectangle 502. Initially, there are no direct links associated with the page. However, over time, as social-network participants access the page and express interest in the page, by various mechanisms discussed below, the social-network participants become directly linked to the page. FIG. 5 shows a time progression of direct linking to the originally non-linked organization page 502. At a first point in time, represented by page 504, three social-network participants 506-508 have expressed interest in the page, through mechanisms discussed in greater detail below, as a result of which they have become directly linked 510-512 to the page. At a next, subsequent point in time, represented by page 514 in FIG. 5, additional direct links have appeared. Each arrow in FIG. 5, such as arrow 503, represents the passage of time.

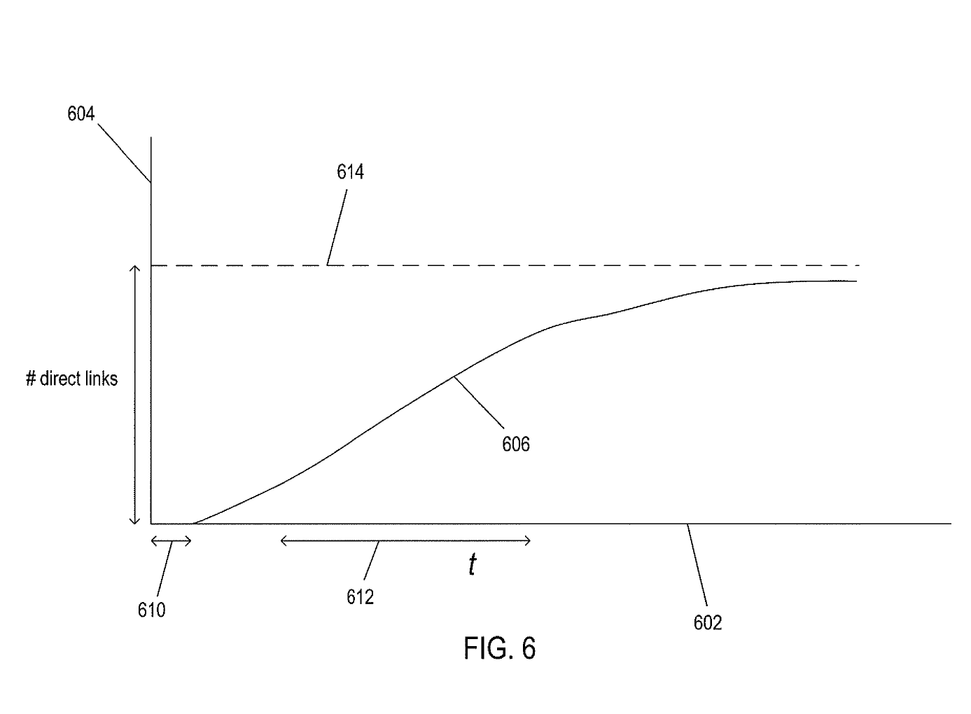

FIG. 6 illustrates, in graphical form, the accretion of direct links to an organization's social-network page over time. In FIG. 6, the horizontal axis 602 represents time and vertical axis 604 represents the number of direct links to a social-network page. Curve 606 represents the number of direct links as a function of time for the organization's page (302 in FIG. 3). This curve generally has a sigmoidal shape. An initial period of time 610 passes before the page is discovered by any social-network participant. Initially, the rate of accretion of direct links to the page rises to a study-state rate, represented by the near linear increase over time during interval 612, and then begins to decrease and approach a maximum number of links, represented by dashed horizontal line 614. As time progresses, the number of direct links may fluctuate or decrease as the page gets older, and the curve may fall to zero in the case the page is deleted from the social network. Many different types of curves may be exhibited by particular pages posted by particular organizations in particular social networks. However, in general, however the curves vary, there is generally an initial lag time and a maximum number of direct links, since it takes a finite amount of time for social-network participants to discover a new page and because there are a finite number of social-network participants.

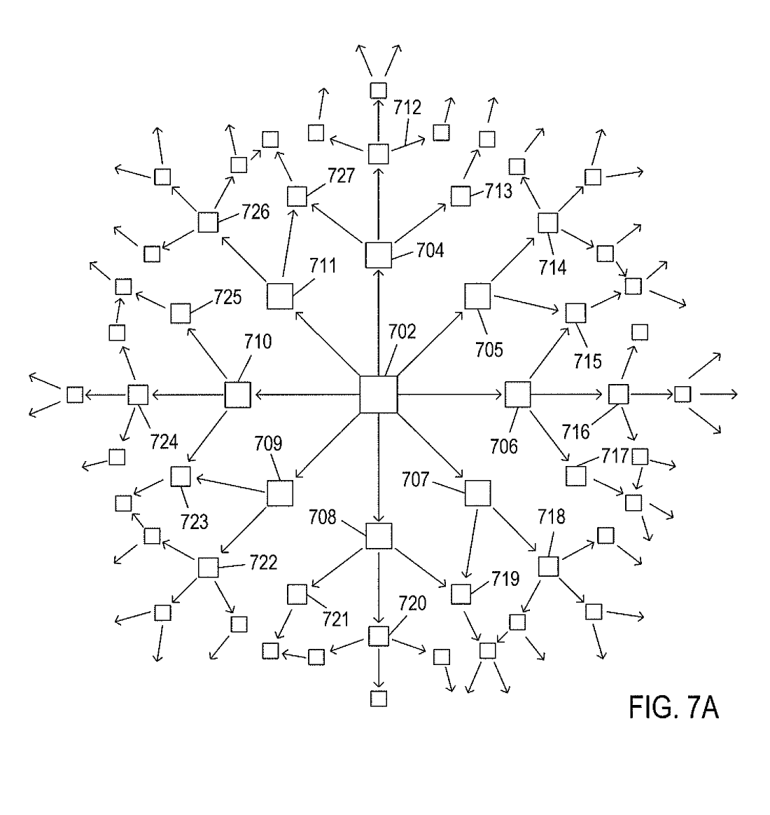

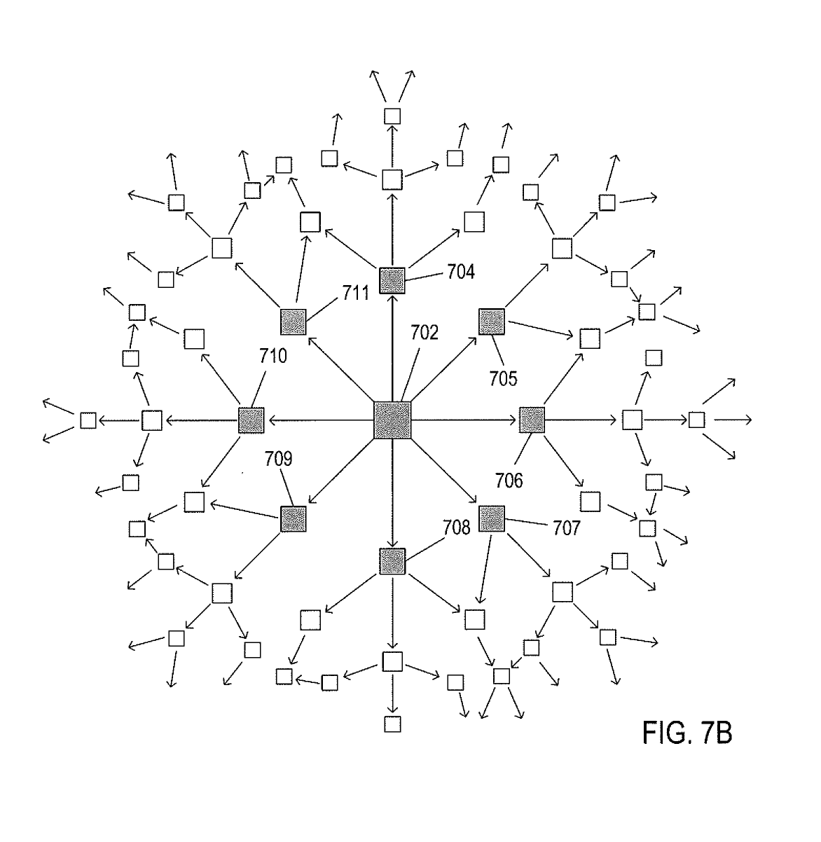

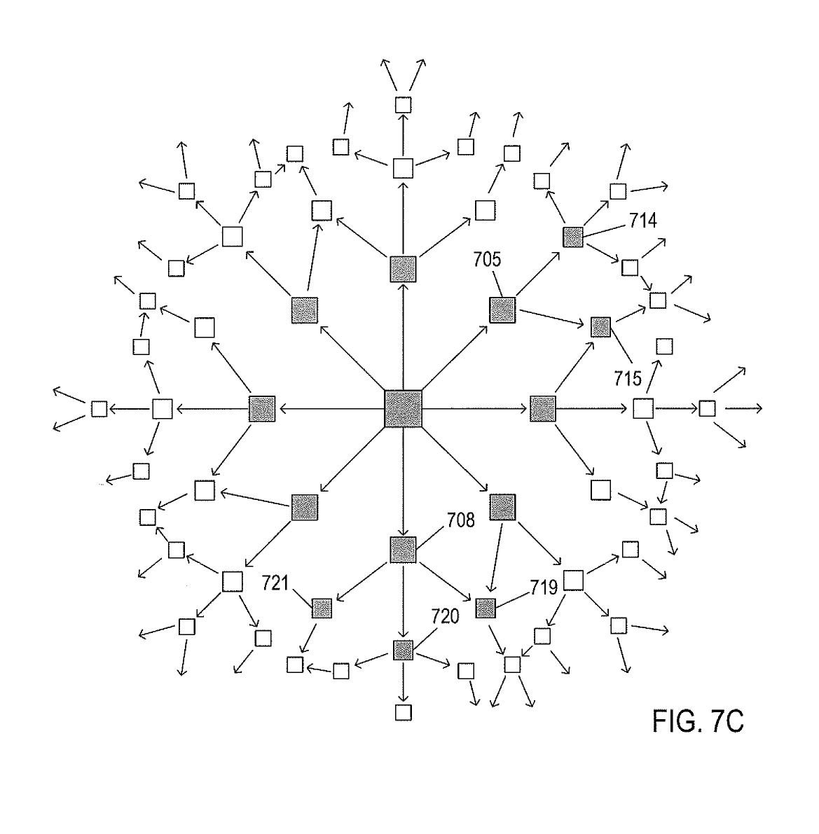

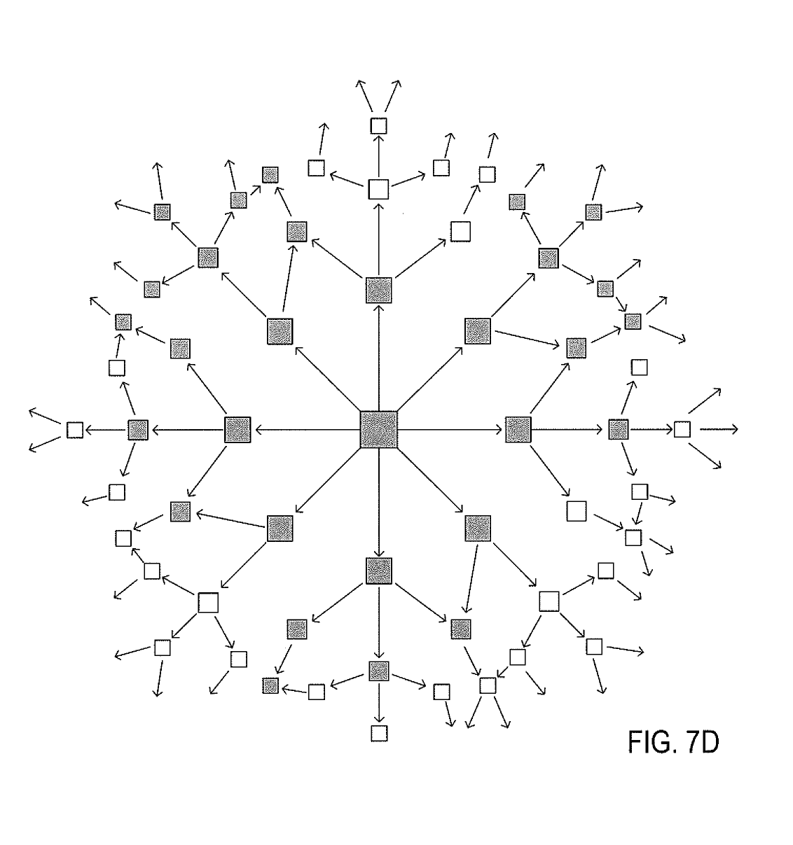

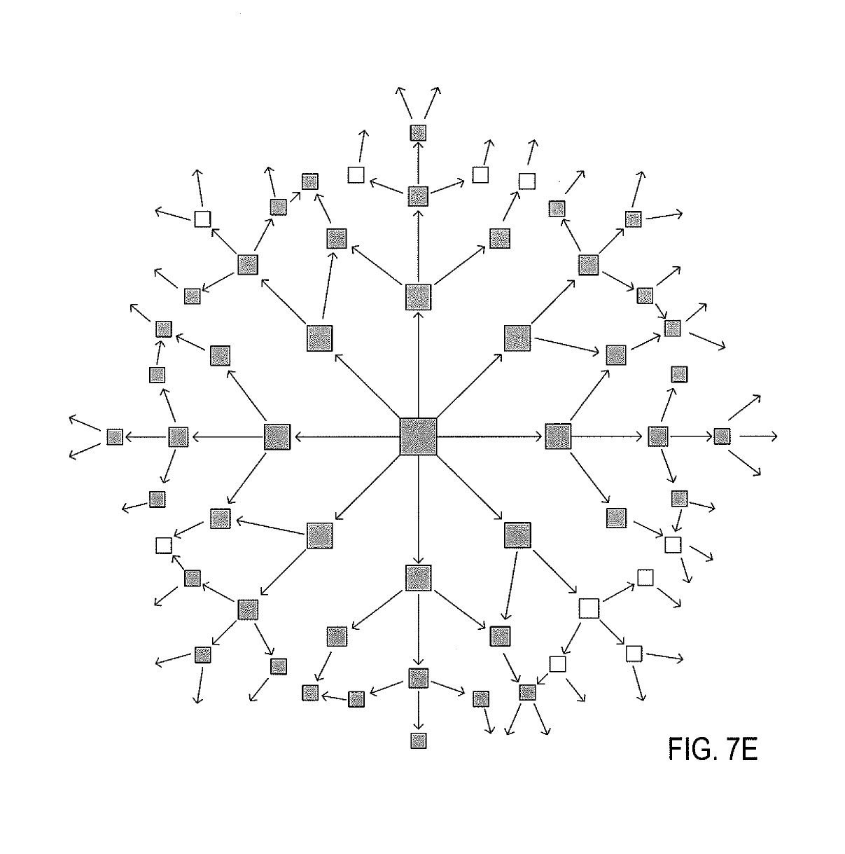

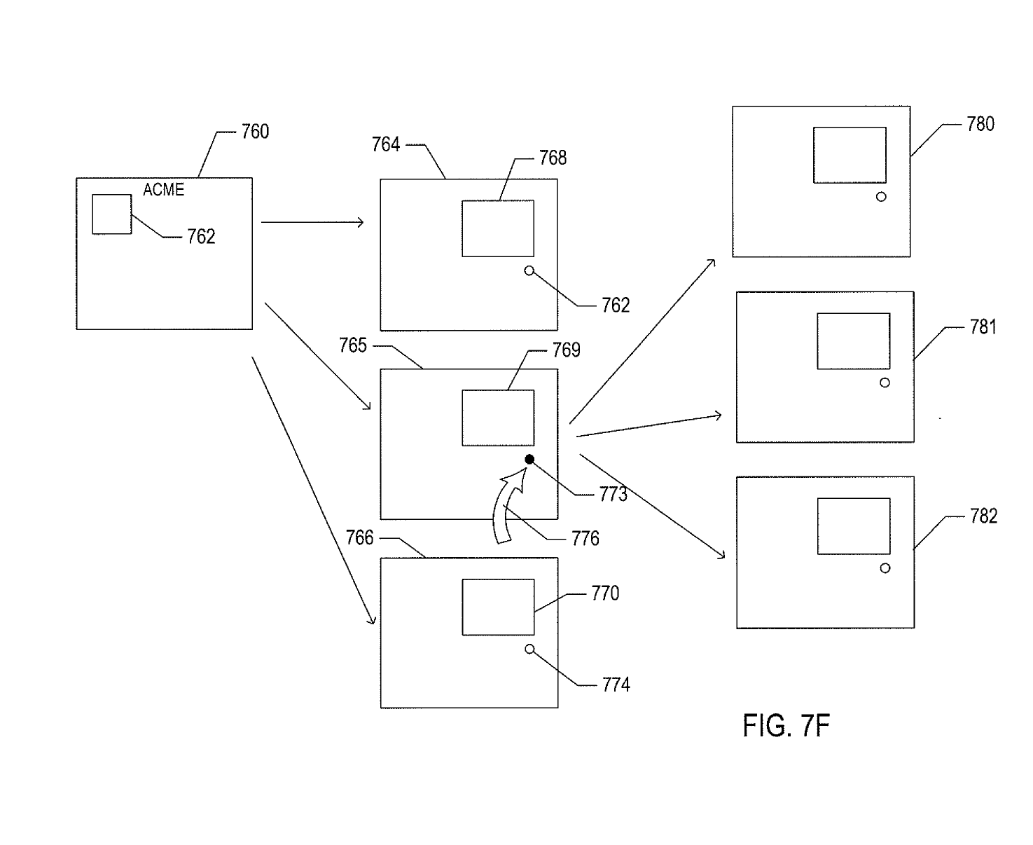

When the organization posts a post to a social-network page associated with the organization, the post propagates, over time, to social-network participants. FIGS. 7A-F illustrate post propagation in a social network. FIGS. 7A-E all use the same illustration conventions, next described with reference to FIG. 7A. In FIG. 7A, the organization and the page on which a post is posted by the organization is represented by a central rectangle 702. The social-network participants directly linked to the page associated with the organization include those social-network participants directly connected by arrows with the page, represented by rectangles 704-711. Those social-network participants directly connected to this first-level of social-network participants comprise a second level, or sphere, of social-network participants connected to the page by two links. In FIG. 7A, this second sphere includes the social-network participants represented by rectangles 712-727. In similar fashion, third-level, fourth-level, and additional levels of social-network participants linked to the page by three, four, and greater numbers of links can be determined. It should be noted that the number of levels does not increase indefinitely, because the social network is finite in size. Moreover, multiple participants of one level may link to a single participant in the next level, so that the size of levels does not indefinitely increase geometrically or exponentially. It should also be noted that, although FIG. 7A appears to be relatively symmetrical, the symmetry arises from the need to position the social-network participants spatially for clarity of illustration. In fact, in actual social networks, the dense graph of links emanating from a particular page may appear quite chaotic and non-symmetrical, however illustrated. For preciseness of explanation, in the following discussion, the phrase “social-network participant” is often shortened to “node,” because the social-network participants correspond to nodes in a graph of links, such as that shown in FIG. 7A. Finally, it should be noted that the number of direct nodes for a particular page may range from tens to hundreds to thousands, tens of thousands, and more nodes, and the total number of nodes in a particular graph may exceed millions of nodes.

FIGS. 7B-E illustrate a time progression following the post of a post by the organization to the social-network page (702 in FIG. 7A) associated with the organization. In FIGS. 7B-E, those nodes that have received the post are indicated with shading. As shown in FIG. 7B, as soon as the organization posts the post to the organization's social-network page, those nodes directly linked to the page receive the posts in a relatively short period of time. Thus, in FIG. 7B, the page is shaded, since the post has been posted to the page by the organization 702, and all the first-level nodes 704-711 are shaded to indicate that the post essentially immediately propagates to this first level of nodes.

In general, this initial propagation of the post represents an insignificant fraction of the total number of social-network participants. Initially, there is significant lag time between the initial propagation to directly linked nodes, shown in FIG. 713, and subsequent propagation. The subsequent propagation depends on interest events occurring with respect to those nodes already having received the post. Interest events generally require some type of participation or input from a social-network participant that serves to push the post out to those additional social-network participants directly linked to the social-network participant who generated the interest event. As shown in FIG. 7C, the subsequent propagation initially begins relatively slowly. In FIG. 7C, interest events have occurred with respect to nodes 705 and 708, resulting in propagation of the post to nodes 714-715 and nodes 719-721. In FIG. 7D, additional interest events result in further additional propagation of the post, and in FIG. 7E, which shows the graph of links at a point later in time that FIG. 7D, even additional propagation has occurred.

FIG. 7F illustrates interest-event-dependent propagation of posts. In FIG. 7F, rectangle 760 represents the organization's social-network page and rectangle 762 represents a post to that page. The post is immediately propagated to three directly linked nodes 764-766 where the post is displayed to social-network participants 768-770 on the social-network participant's display device along with an input feature 772-774 to which the social-network participant may input a mouse click or other type of input to indicate interest in the post. When the first-level social-network participant 765 inputs a mouse click to input feature 773, as represented by arrow 776, then the post propagates to each of three additional social-network participants 780-782 directly linked to social-network participant 765.

There are many different types of interest events in various different social networks. In certain social networks, a social-network participant may indicate favorable interest, unfavorable interest, may enter a text comment associated with a post, or may otherwise supplement the post, all which constitute interest events. When posts propagate to a social-network participant, the post may appear on a special display screen or page associated with the social-network participant. It should be noted that, in all cases, information contained in a post is disseminated via underlying electronic communications networks and media and is stored in physical devices, including electronic memories and/or mass-storage devices.

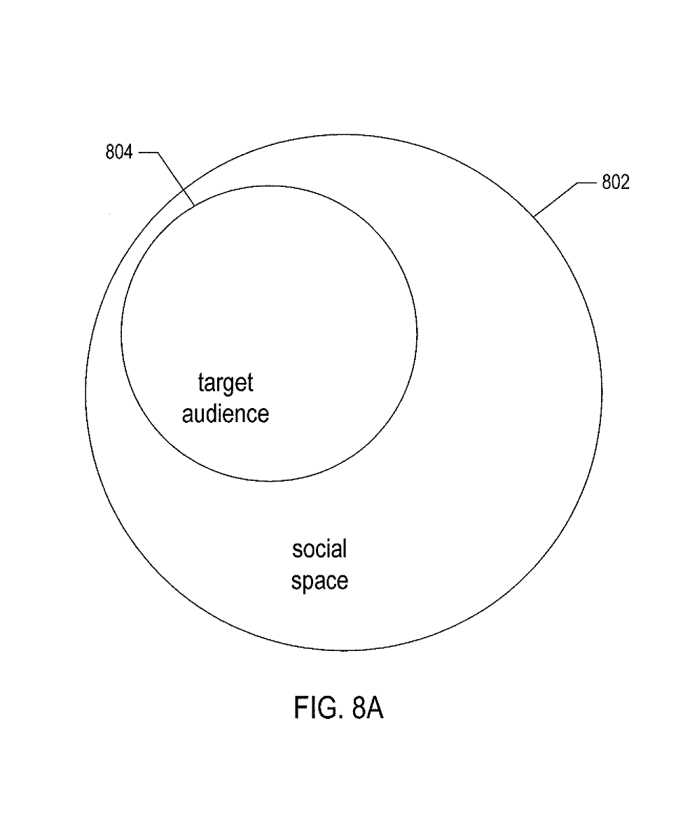

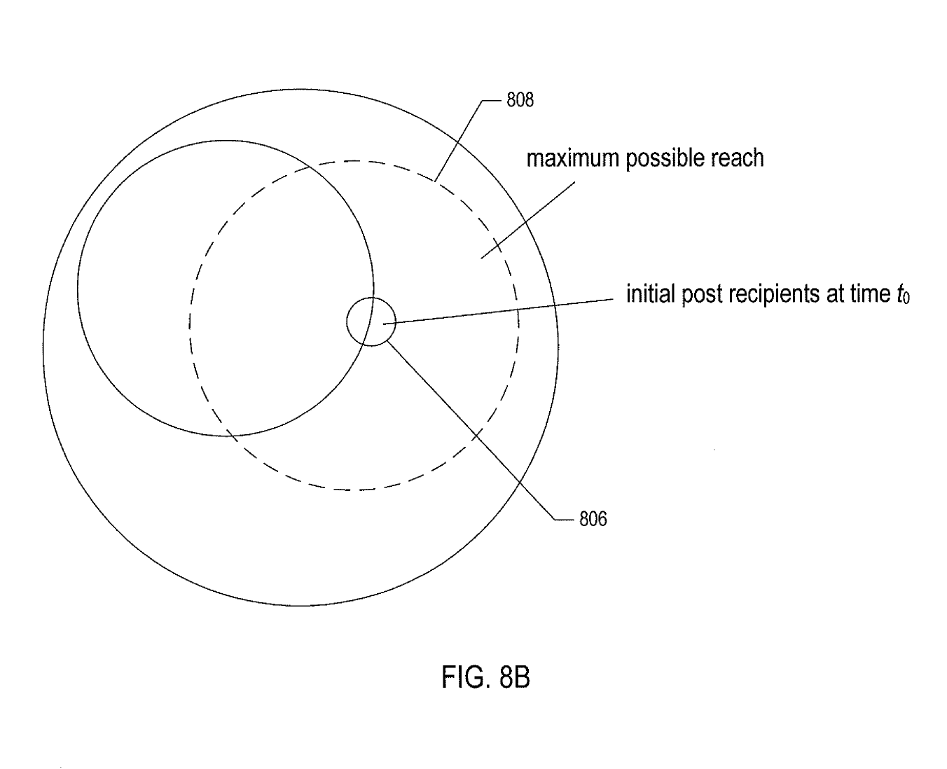

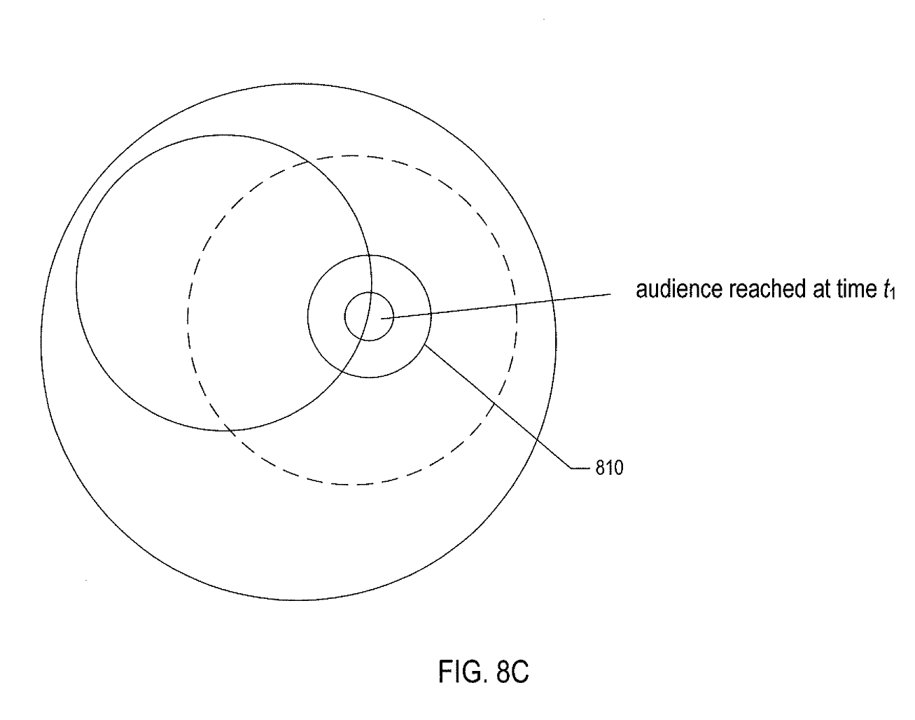

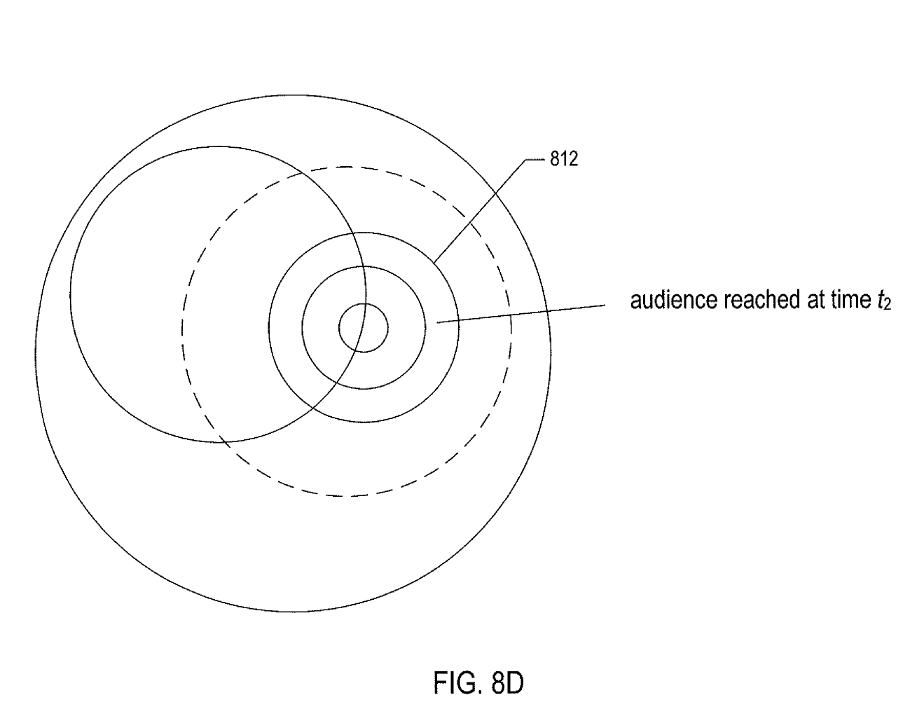

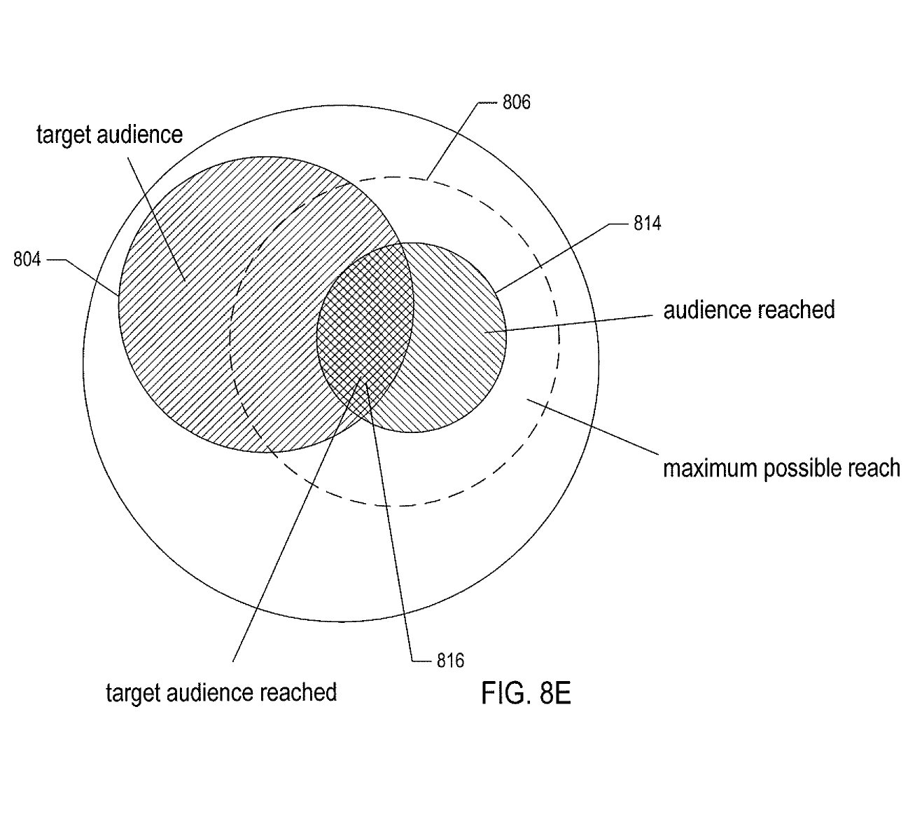

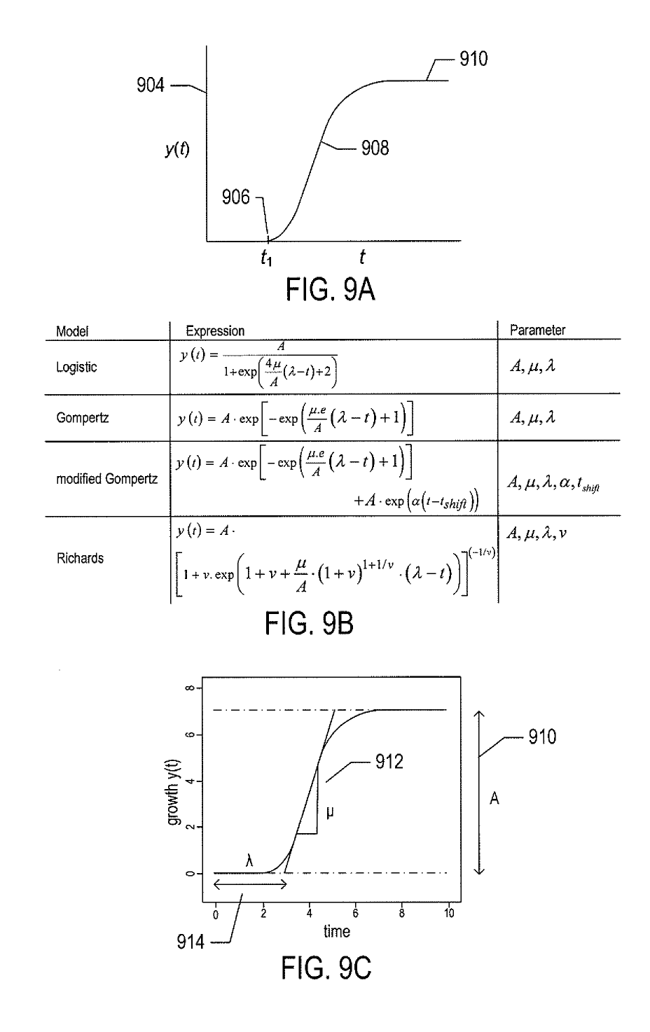

FIGS. 8A-E illustrate advertising via posts within a social network. FIGS. 8A-E use a Venn-diagram-like presentation to discuss various sets of social-network participants. FIG. 8A shows two sets of social-network participants that define an advertising challenge. The large disk labeled “social space” 802 represents all of the participants in a particular social network. The smaller disk labeled “target audience” 804 represents those participants of the social network to which an organization wishes to disseminate information contained in a post. The target audience can be characterized by any of various attribute values. As one example, a motorcycle-retailing organization may wish a post to reach male social-network participants between the ages of 18 and 30 with incomes above $40,000 per year, a select audience which the organization feels is the most receptive to advertising related to fast, four-cylinder sport motorcycles. When the organization posts a post on a social-network page associated with the organization, as discussed previously with reference to FIG. 7B, those social-network participants directly linked to the page relatively immediately receive the post. These social-network participants are represented by disk 806, labeled “initial post recipients at time t₀” in FIG. 8B. There is a theoretical set of all possible social-network participants that can be reached by paths of links from the initial recipients, represented in FIG. 8B by the disk bounded by the dashed circle 808 and labeled “maximum possible reach.” The maximum-possible-reach set is generally a subset of the social-network space 802. At a time t₁, as illustrated in FIG. 8C, the set of social-network participants who have received the post expands to disk 810 and, at time t₂, as shown in FIG. 8D, the set of social-network participants that have received the post expands further to disk 812. Eventually, for any particular post, after a period of time, an essentially static, final set of social-network participants will have received the post. As shown in FIG. 8E, this set of social-network participants is represented by disk 814, labeled “audience reached.” As shown in FIG. 8E, the audience-reached set is generally a subset of the maximum possible reach 808. The intersection between the audience-reached subset of social-network participants 814 and the target-audience subset of social-network participants 804 is shown in FIG. 8E as the doubly-crosshatched region 816 labeled “target audience reached.” One goal for an organization advertising through social-network posts is to maximize the size of the audience-reached subset 814. Another goal may be to maximize the size of the target-audience-reached subset 816. Additional goals may be to maximize the rate of increase of the audience-reached subset 814 or the target-audience-reached subset 816 during some period of time, generally a period of time between the initial posting of the post and an effective post lifetime. Many other types of goals of this nature may be defined by an organization. The current application is directed to a method and system for providing information with regard to the time behavior of posts of posting organizations in order to evaluate posts with respect to such goals. FIGS. 9A-C illustrate models used by the currently disclosed methods and systems for estimating characteristics and parameters of post propagation in a social network. FIG. 9A shows the general time behavior of post propagation in a social network. In FIG. 9A, the horizontal axis 902 represents time and the vertical axis 904, labeled “y(t),” represents either the number of social-network participants which a post reaches or the number of interest events that occur with respect to the post. Clearly, the number of social-network participants reached by a post is related to the number of interest events associated with the post by a multiplier greater than 1.0. As discussed above, for an initial period of time, up to time t₁ 906, little propagation occurs. Then, the rate of propagation steeply increases to a relatively high rate, as represented by the steeply sloped, nearly linear portion of the curve 908 plotted in FIG. 9A. Eventually, the rate of propagation slows and the number of interest events or recipients reaches a maximum value, at which the curve is essentially flat 910. This type of curve is described as being sigmoidal. The reason that the time behavior of post propagation, when plotted in FIG. 9A, produces a sigmoidal curve is, as discussed above, related to the nature of link graphs, such as those shown in FIGS. 7A-E and the interest-event-dependent propagation model of many social networks. Because interest events are necessary for propagation beyond a first level of nodes, and because interest events take time, it is not surprising that there is an initial period of slow propagation. As propagation begins, because of the potentially large expansion due to the initial geometrical or exponential increase in the number of nodes in successive levels, the rate of propagation tends to quickly increase as each interest event potentially spawns multiple subsequent interest events. However, because the social network is of finite size, and because the social network is usually characterized by an average non-intersecting path length, the number of recipients generally begins to quickly decrease following rapid initial expansion.

As shown in FIG. 9B, there are many different possible mathematical models for the time behavior of post propagation. Certain of these models produce sigmoidal curves and other of the models produce generally sigmoidal curves with one or more intermediate local maxima that precede the final steady-state maximum value. Other types of models include time-series models, other cumulative models, Markov models, and programmed models. The models shown in FIG. 9B are expressions that represent the number of interest events or recipients of a post, y(t), as a function of the variable t. The expressions include at least three parameters: A, μ, and λ. FIG. 9C illustrates the meaning of these parameters. The parameter A represents the maximum y value reached when the time-behavior curve flattens at the steady-state level 910. The parameter μ is associated with the slope of the steeply sloped, near-linear portion of the curve 912, and the parameter is associated with the length of the initial lag time 914 before propagation begins to rapidly increase.

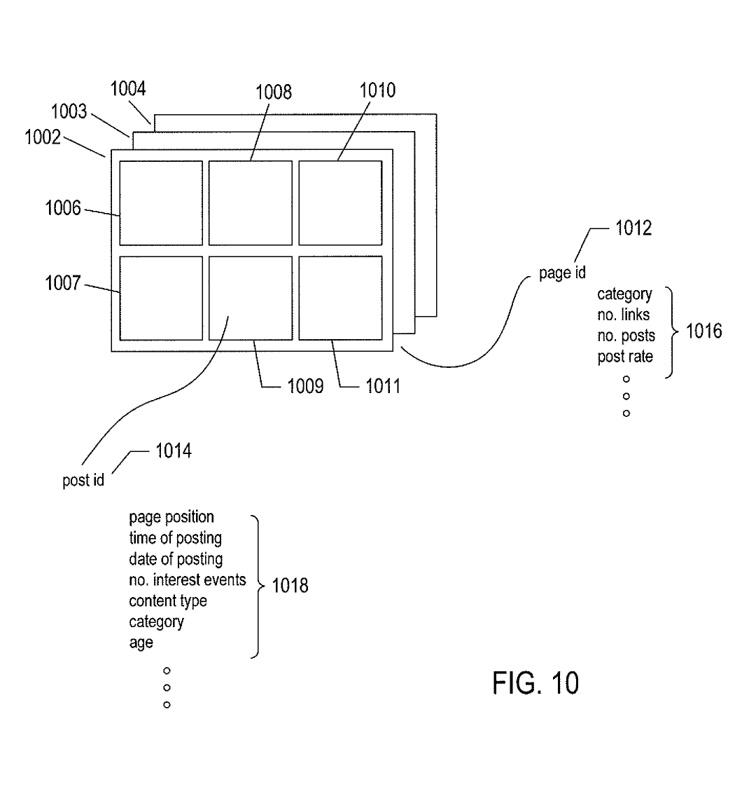

FIG. 10 illustrates certain of the attributes that may be associated with pages and posts. As discussed above, a particular organization may have various social-network pages 1002-1004 with which the organization is associated. Each social-network page may accommodate a number of posts, such as posts 1006-1011 within page 1002. One attribute associated with pages is therefore a page ID 1012 that identifies a particular page within the social-network pages associated with an organization. A post ID 1014 is an attribute of a post that identifies the post. A post ID may be an absolutely unique identifier for all of the posts posted by the organization or it may be a relative identifier for a particular page, so that the post is uniquely identified by a combination of the post ID and page ID. Pages may be associated with many different additional attributes 1016, including the category of the subject matter to which the page is associated, the number of direct links to the page, the number of posts accommodated by the page, the rate of posting to the page, and many other such attributes. Certain of these attributes may be directly obtained through an information interface provided by a social network. Other of the attributes may be inferred, over time, by monitoring the time behavior of posts within the pages and the information provided by a social network. Likewise, a page may be associated with many different page attributes 1018, including the position on a page at which the post is posted, the time that the post is posted, the date that the post is posted, the number of interest events of various types associated with the post, the content type of the post, such as the type of information included in the post, the subject category of the post, the age of the post in minutes, hours, days, or some other time unit, and many other similar types of information.

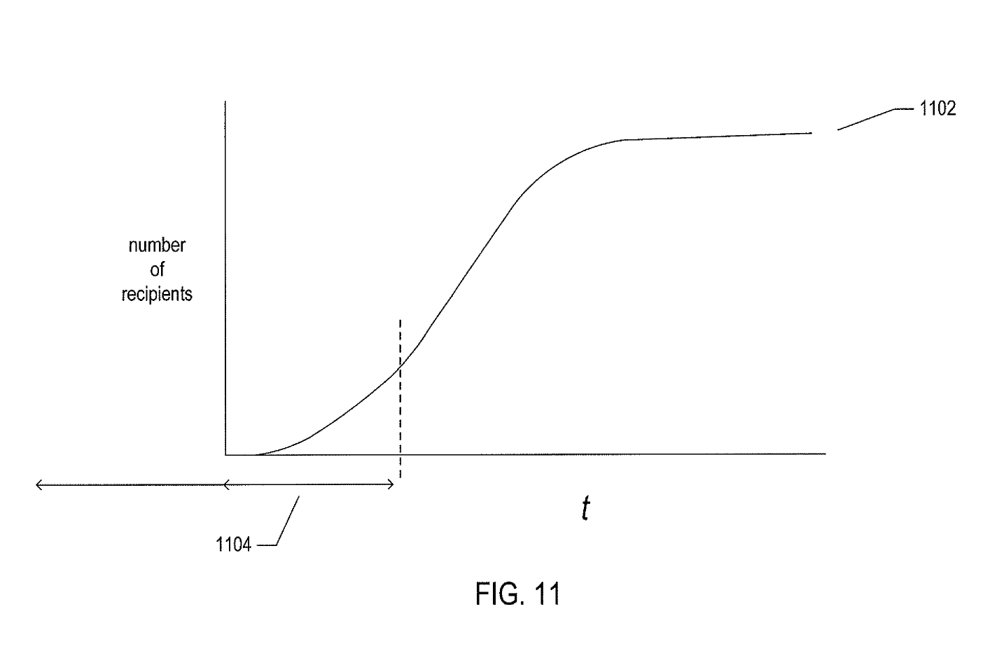

FIG. 11 illustrates a period of time in which an advertiser may be most interested in characterizing the time behavior of post propagation. Clearly, once a post has reached the saturation level 1102, the number of social-network recipients of a post can be relatively straightforwardly inferred either directly or from the number of interest events associated with the post, information that is often available from a social-network site. This type of information may be useful for retrospective analysis of post effectiveness, but is generally of less interest to an advertiser than whatever information is available with regard to the propagation time behavior of the post within an initial time interval 1104 preceding and immediately following posting of the post. Were it possible to quickly to ascertain, for example, the number of social-network participants that will eventually receive the post, the number of target-audience social-network participants that will eventually receive the post, and/or the number of social-network participants or target-audience social-network participants that will receive the post subsequent to the current time, these projected characteristics and parameters would allow an advertiser to consider removing the post and replacing it with another post, editing the information contained in the post, moving the post to different locations on a page, and carrying out any of many other types of actions in order to optimize post posting with respect to any of the above-mentioned goals. The currently disclosed method and systems model time behavior of post propagation and therefore seek to develop accurate models associated with post and page attributes that provide for prediction of the time behavior of post propagation preceding posting and during the initial time period following posting.

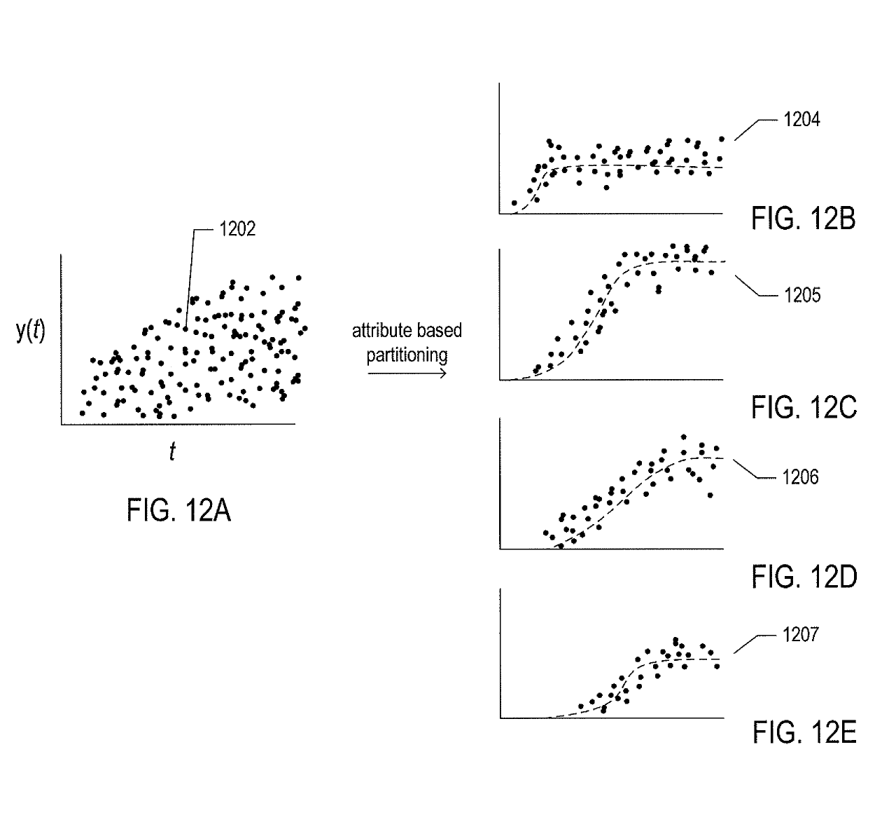

FIGS. 12A-E illustrate resolution of collected data into data subsets for which accurate predictive models can be estimated. FIG. 12A shows a plot of the number of interest events associated with posts at particular points in time for many different posts posted to a particular social-network page. The data points generally occupy a relatively large area, and appear as a diffuse cloud of data points 1202 into which any number of different models might be fit. A least-squares fit of any particular model to the cloud data appoints would provide a model of very low predictive power, since the model would present the average of potentially many different types of post-propagation curves or behaviors. However, it may be possible to select subsets of this data, as shown in FIGS. 12B-E, that are far less uniformly distributed and to which models may be fit that provide relatively high predictive power. Partitioning of the original data points 1202 into data-point subsets 1204-1207 can be carried out based on page and post attributes. For example, it may be found that the time behavior of post propagation is largely determined by the subject matter and content type of the post, in which case partitioning of the collected data into data subsets described by different values or ranges of values of these two attributes may resolve the accumulated data into data subsets to which highly predictive models can be accurately fit. The currently disclosed methods and systems employ such accumulated-data partitioning based on attribute values to create highly predictive models associated with attribute values and ranges of attribute values. Thus, the attribute values associated with a page and a post can be employed to choose the best post-propagation model for the post, and various characteristics and parameters of time-dependent propagation of the post can be estimated from the model. For example, as shown in FIG. 9C, a predictive model for a post can be selected, based on post-associated and page-associated attribute values. From the selected model, the total number of interest events that will be associated with the post can be estimated by the value of the parameter A for the model, the maximum rate of propagation can be obtained from the parameter μ for the model, and the lag time associated with post propagation can be estimated from the parameter A. Many other characteristics and parameters may be estimated for the post based on combinations of parameters or additional parameters associated with the model. Other types of models provide other parameter values and characteristics that allow post-propagation-time-behavior estimates to be made.

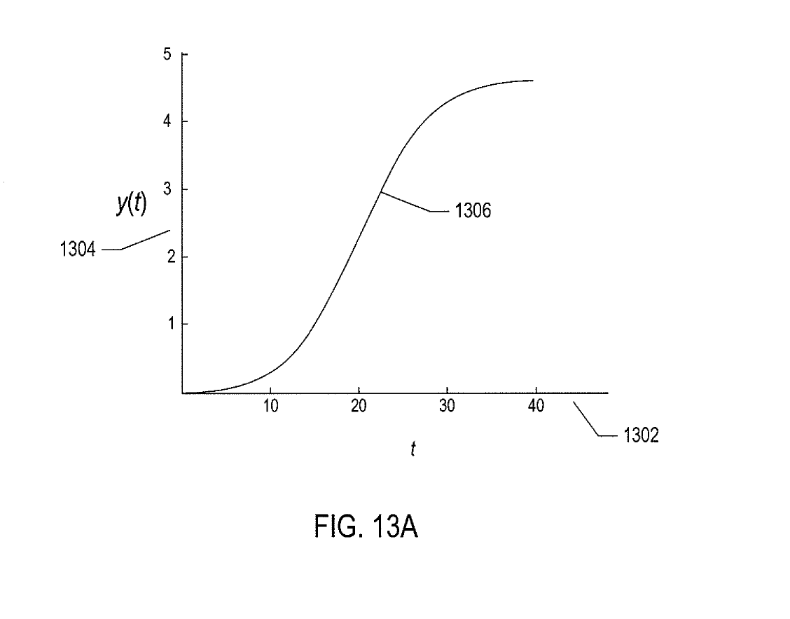

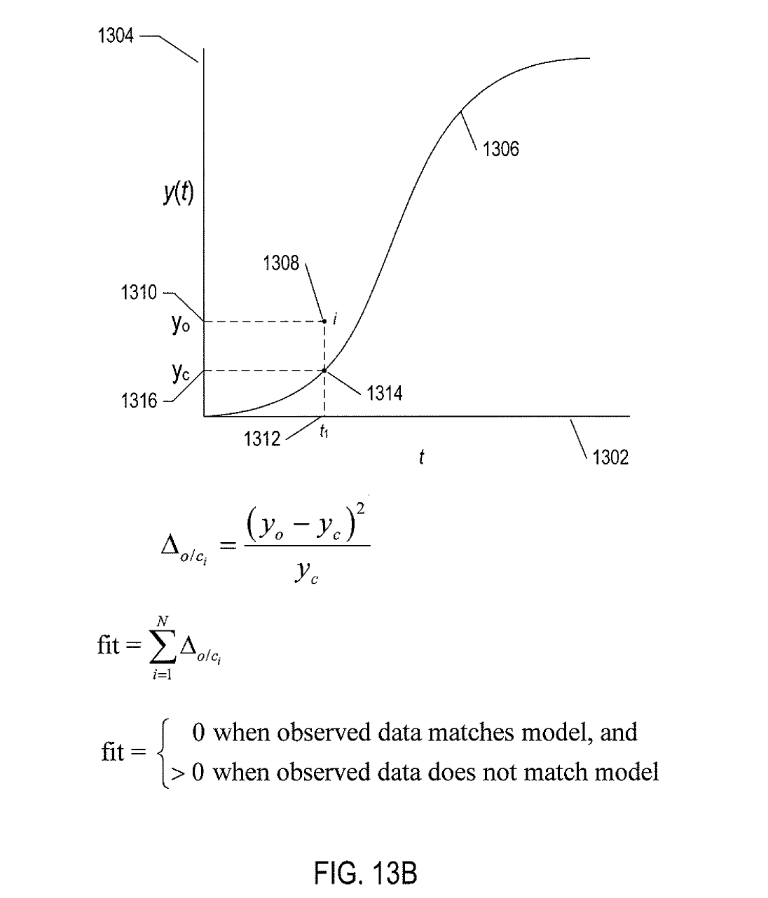

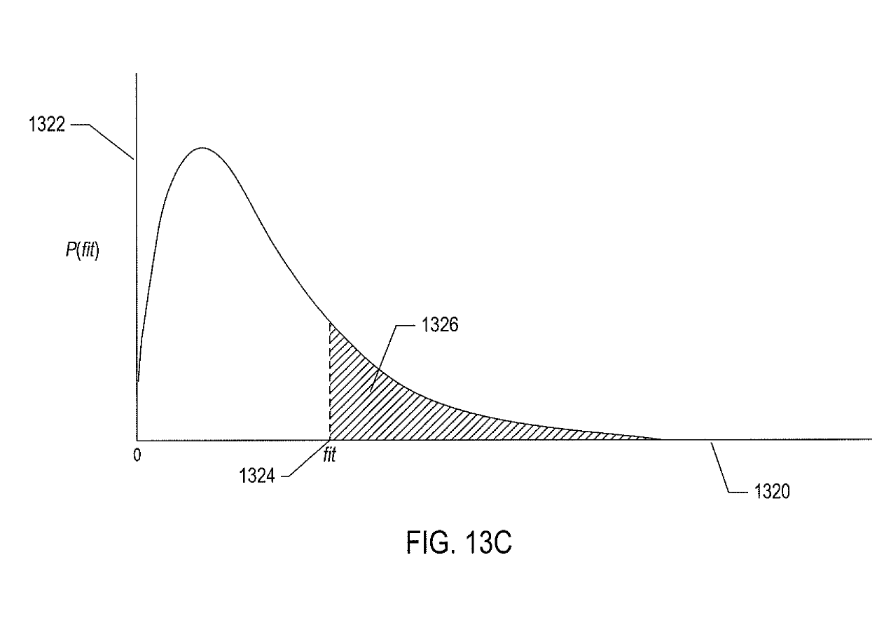

FIGS. 13A-C illustrate computing a fitness metric for a particular model with respect to a collection of data points. FIG. 13A shows a plot, with a horizontal time axis 1302 and vertical axis 1304 representing the number of interest events associated with posts or number of recipients receiving posts, of a post-propagation time-behavior model 1306. A parameterized model generated for a collection of data points is generally only an estimate and, because of all the different factors that may affect the time behavior of post propagation, the parameterized model is generally an estimate for an average time behavior of post propagation based on many different posts. Were the model curve to be plotted within the dense clouds of data points of even a resolved data subset, generally only a very few of the observed points would actually fall on the model curve. Models are selected and evaluated by evaluating how well the data fits the model. There are many statistical methods that may be employed to compute the fit of a model to experimental data. FIGS. 13B-C illustrate one such method. FIG. 13B shows the model curve in a graphical plot similar to that shown in FIG. 13A along with one of the observed data points 1308. A vertical line segment passing through the observed data point 1308 also passes through the model curve at point 1314 and through the time axis at point 1312, the time coordinate of which is referred to as t₁. The y(t) coordinate 1310 of the data point is labeled yₒ and the y(t) coordinate 1316 of the point on the model curve corresponding to time t₁ 1314 is labeled y_{c}. A discrepancy Δ_{o/c}_{ᵢ} between the observed data point i 1308 and corresponding model point 1314 can be computed as:

$${Δ}_{o / {c}_{i}} = \frac{{( {y}_{o} - {y}_{c} )}^{2}}{{y}_{c}}$$

A fit value for the curve with respect to the observed data can be computed by summing all of the discrepancies for all of the data points, as follows:

$$fit = {\sum }_{i = 1}^{N} {Δ}_{o / {c}_{i}} .$$

Were all of the data points to fall along the model curve, the fit value would be 0. As the observed data departs further from the model curve, the fit value increases.

As shown in FIG. 13C, it is often the case that fit values calculated from various different data sets fall into a particular type of probability distribution. One such probability distribution is shown in FIG. 13C. The vertical axis 1322 represents the probability of observing a particular fit value and the horizontal axis 1320 represents the different possible fit values. For a particular fit value, such as fit value 1324, the area under the probability-distribution curve to the right of the fit value 1326, shown cross-hatched in FIG. 13C, represents the probability of observing the fit value 1324 or a fit value greater than that fit value. This probability can also be used to evaluate the reasonableness of the model with respect to observed data. When the probability of a fit value equal to or greater than the observed fit value falls below a threshold probability, the model may be rejected.

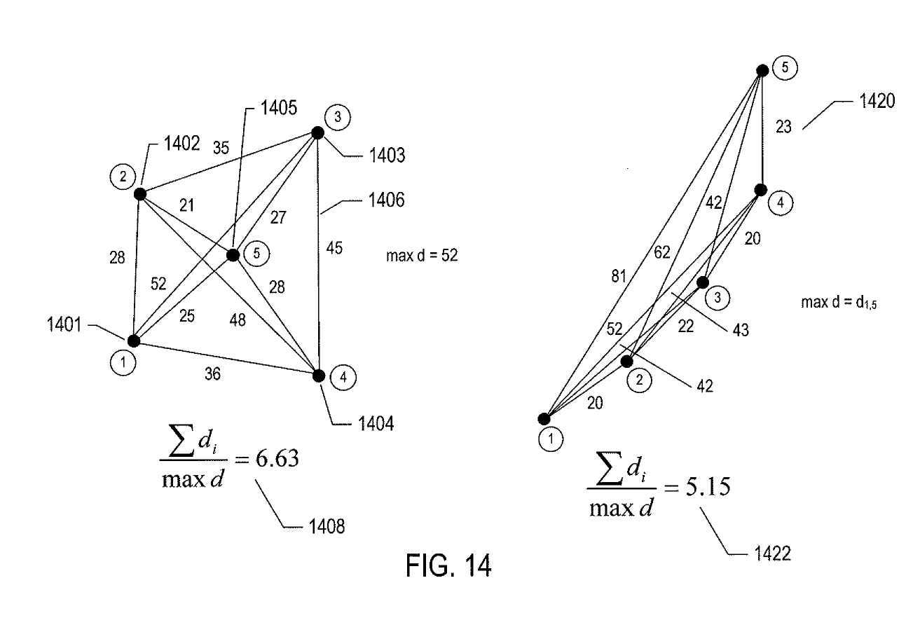

FIG. 14 illustrates a compactness metric that may be used to, at least in part, decide whether the distribution of a set of data points in a y(t) versus t plot is conducive for model fitting. In the left-hand portion of FIG. 14, five data points 1405 are shown within a y(t) versus t. The lines drawn between points and labeled with numbers, such as line 1406 labeled with the number “45,” represent distances between pairs of points. The compactness metric 1408 can be obtained by summing all of these distances and dividing the sum by the maximum distance at any of the two points. In the right-hand portion of FIG. 14, a different set of five points within a y(t) versus t plot 1420 is illustrated in the same fashion as the first set of data points 1401-1404. The compactness metric 1422 computed for this second set of data points is lower than the compactness metric computed for the first set of data points. Clearly, the second set of data points closely corresponds to a curve, such as a sigmoidal curve, than the first set of data appoints. Thus, the lower the compactness metric, the greater likelihood of fitting a model, such as the model shown in FIG. 9B, to the data points. When data sets of different numbers of data points are compared, the compactness metric may be divided by the total number of data points. Many other, more sophisticated metrics for determining the compatibility of a set of data points for curve fitting are possible.

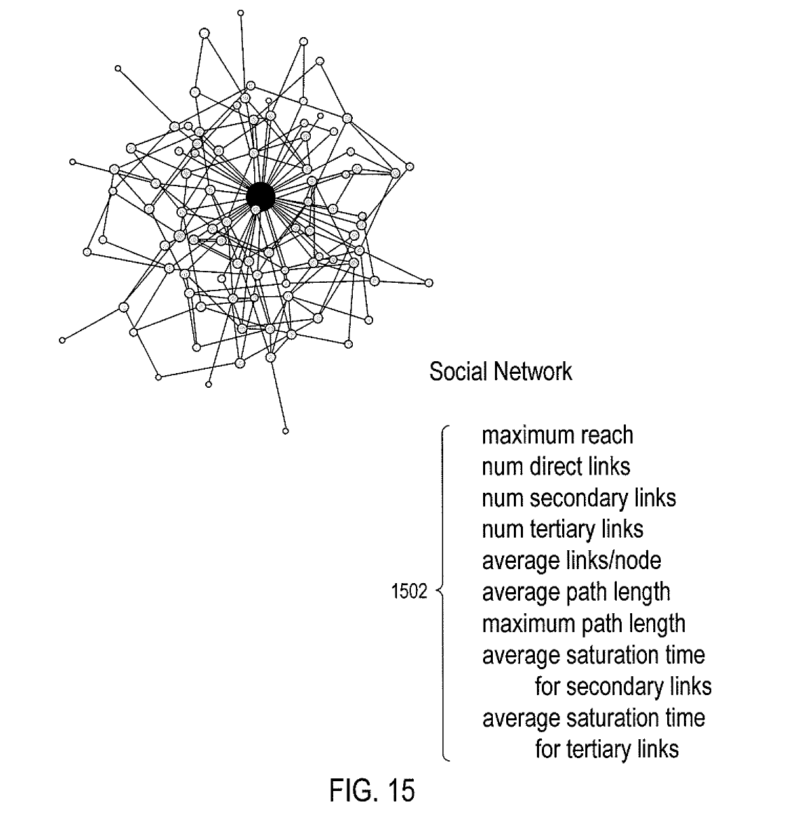

FIG. 15 illustrates attributes associated with social networks. Just as social-network pages and posts may be associated with many different attributes, as discussed above with reference to FIG. 10, the social network itself may be associated with attributes. For example, a social network including: (1) the maximum reach possible for any page within the social network; (2) the number of direct links between social-network participants; (3) the number of secondary links between social-network participants; (4) the average number of links per node; (5) the average path length interconnecting social-network participants without intersecting another path; (6) the maximum path length of a social network; and (7) the average saturation times, second links, and tertiary links; and many additional parameters. These values may be averaged over all pages or over subsets of pages described by various page-attribute values and ranges. Were sufficient information available, even far more detailed information about a social network may be inferred, down to identifiers and attributes for individual social-network participants likely to reside in node levels with respect to an initial set of social-network participants linked to a particular page. The point of FIG. 15 is that, just like pages associated with organizations and posts, a social network itself may be characterized by various attributes and attribute values. Moreover, certain of these attributes and attribute values may be obtained from a social network through an information interface, and others of these attributes and attribute values may be inferred, over time, by monitoring time behavior of post propagation.

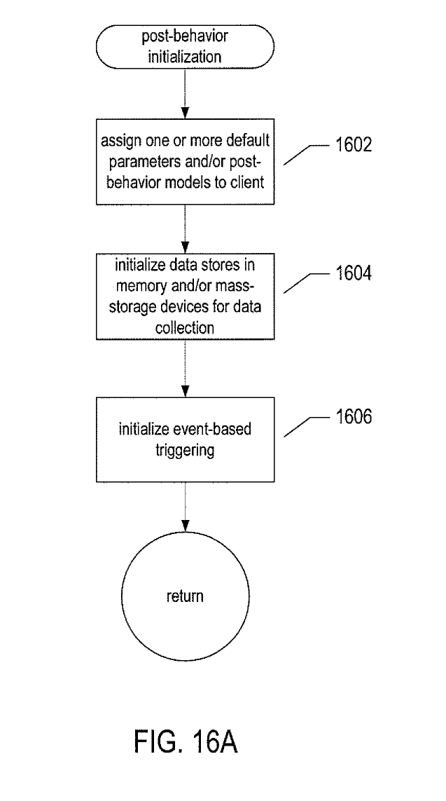

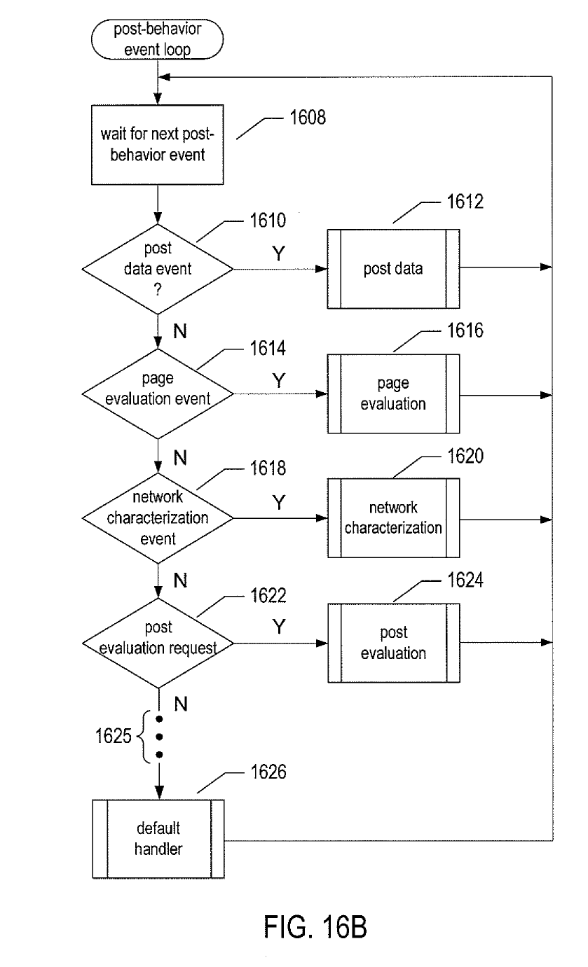

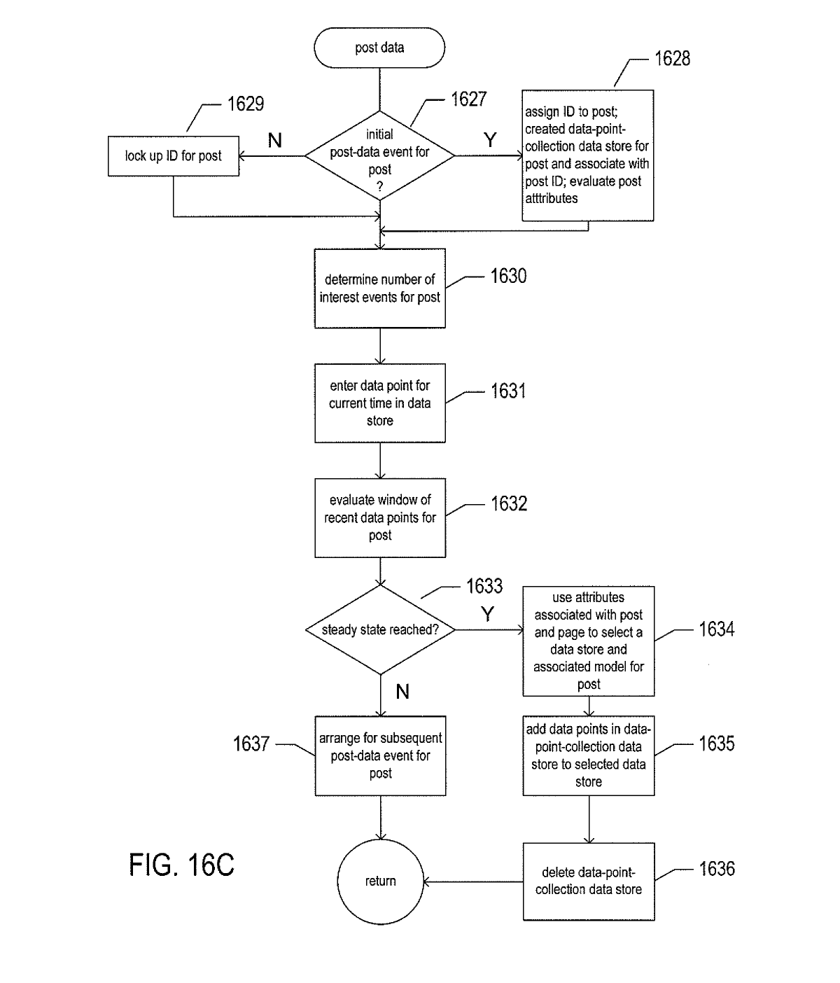

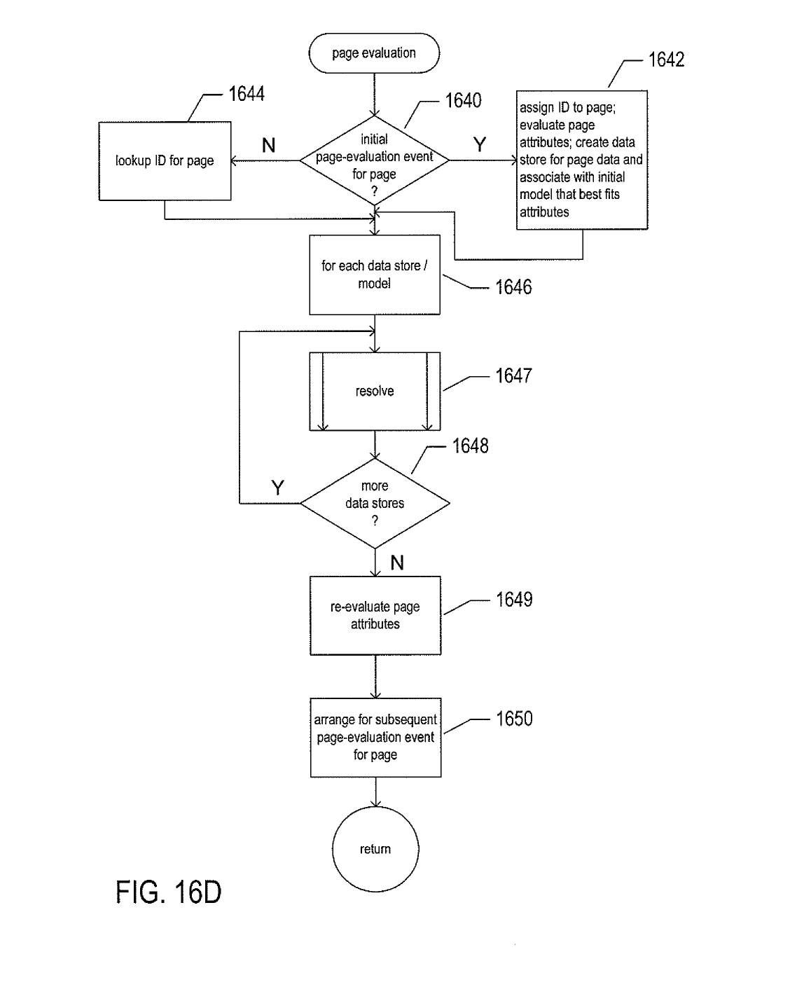

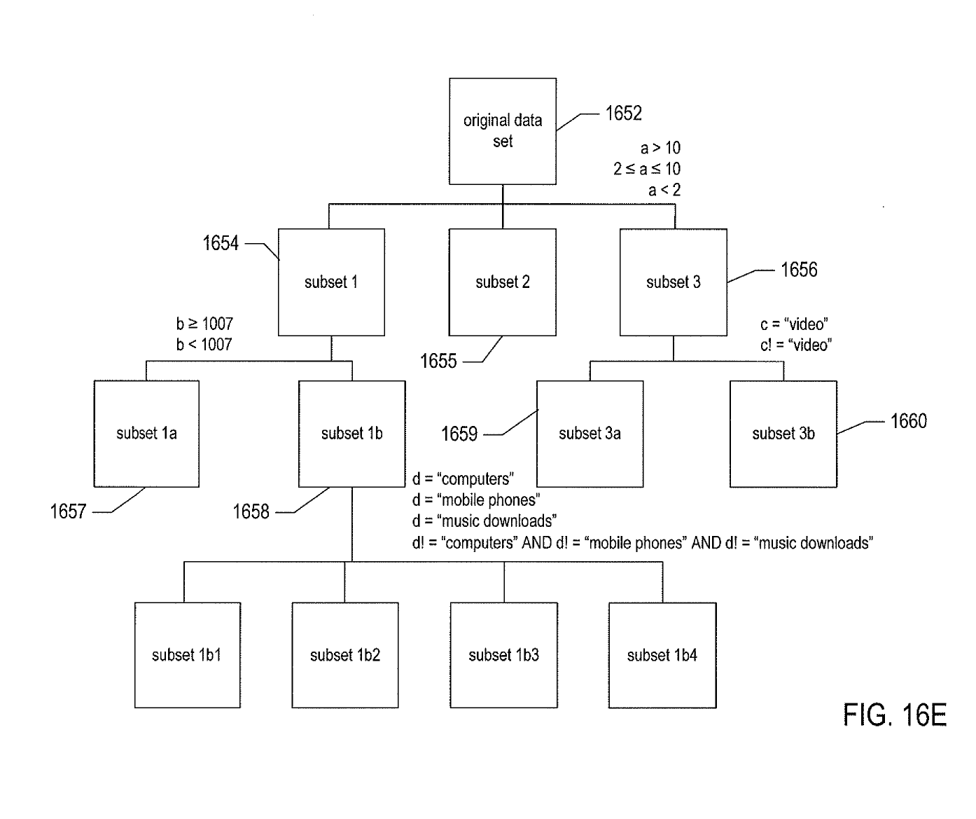

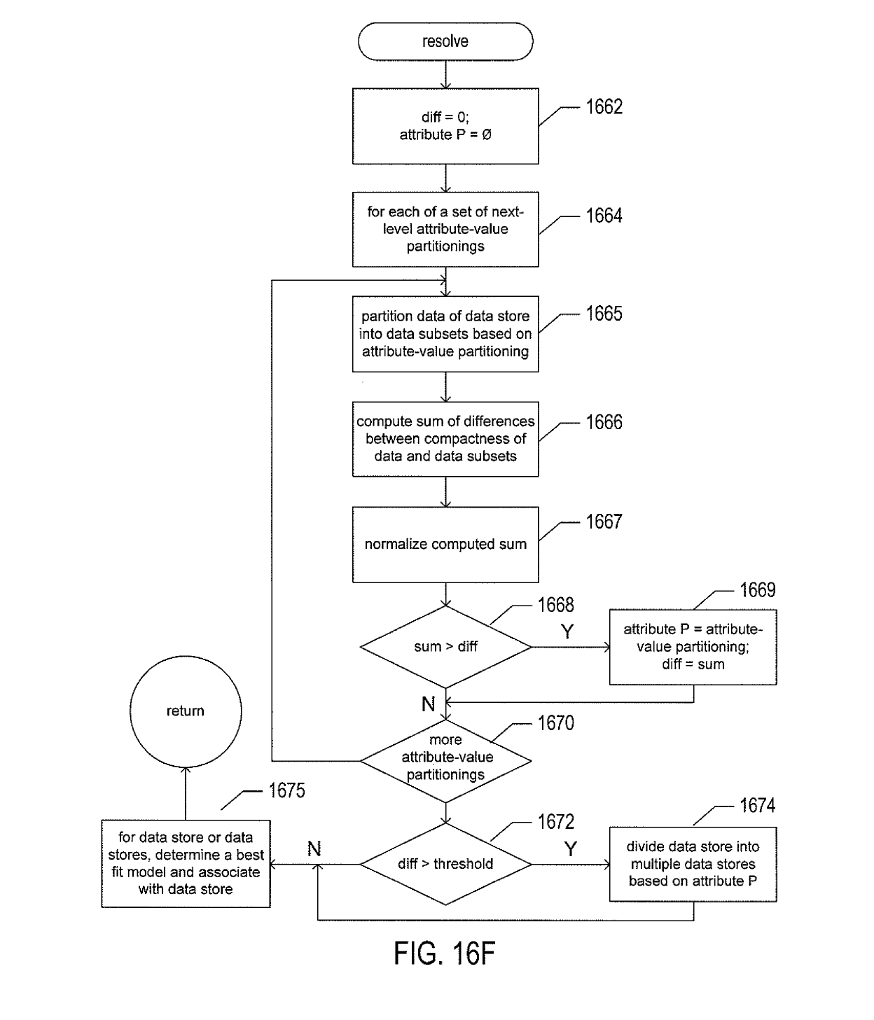

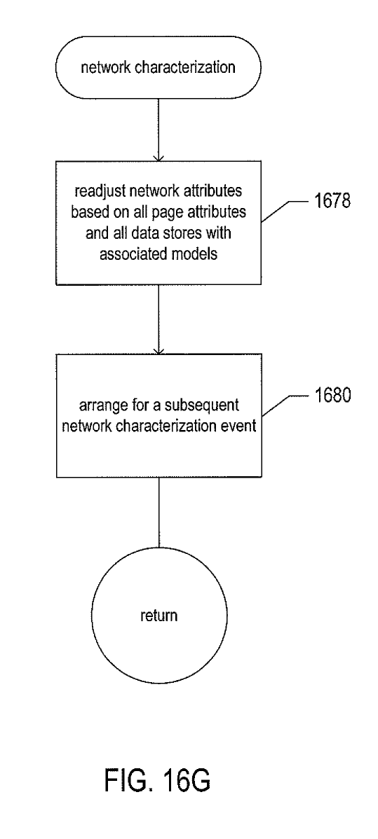

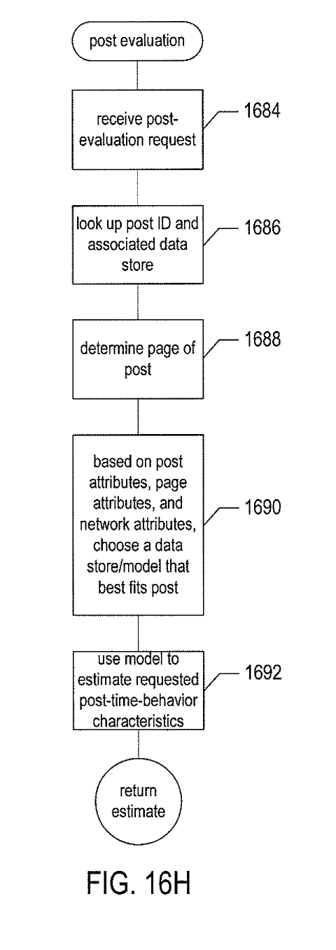

FIGS. 16A-H provide control-flow diagrams and one additional illustration that together describe a method for monitoring post-propagation time-dependent behavior and characteristics in a social network, determining attribute-associated models for post-propagation in a social network, and provide pre-posting and post-posting estimates of the propagation characteristics and parameters for a post based on attributes associated with the post, the page on which the post is made, and the social network. The method disclosed with reference to FIGS. 16A-H may be incorporated into an organization's data center or computing facility, a social-network data center or computing facility, or in an independent, third-party data center or computing facility that provides estimates of propagation characteristics and parameters of posts to organizations and other parties. As those familiar with modern science and technology well appreciate, the described method may be implemented by a large set of computer instructions and underlying computer hardware, with the computer instructions necessarily stored in physical computer-instruction-storage devices, including electronic memories, mass-storage devices, and physical, removable storage media, including CD and DVD disks. Instructions stored in physical devices and executed by processors in computer systems represent the control component of the computer system, and are as physical and tangible as any other computer-system component, including power supplies, processors, memories, and other such components. Those familiar with modern science and technology understand that computer instructions that control computer systems to carry out specialized tasks are not, in any way, abstract and cannot be described as “software only.” Such instructions are physical control elements of a computer system. By contrast, software refers to a sequence of symbols, which may or may not be executable.

FIG. 16A illustrates a post-behavior-initialization routine that initializes an implementation of the currently disclosed method. In step 1602, one or more default parameters and/or post-behavior models are assigned to a client, such as an organization that posts to organization-associated pages. For example, the post-behavior-initialization routine may associate the organization with an initial model, such as a model shown in FIG. 9B, that generally describes post-propagation behavior. The post-behavior-initialization routine may also assign initial values to attributes for the client's social-network pages and initial values to some of the social-network attributes with respect to the social network in which post behavior data is to be accumulated and processed. Next, in step 1604, the post-behavior-initialization routine initializes one or more data stores in memory and/or mass-storage devices for collecting post-propagation data on behalf of the client. Data stores may include relational tables, files, or allocated memory, among other types of data-storage entities available to a computer system. Finally, in step 1606, the post-behavior-initialization routine initializes event-based triggering in order to continuously, periodically, or intermittently monitor post-propagation behavior and monitor and adjust page attribute values and social-network attribute values on behalf of the client. This may involve setting timers, arranging for event-triggered interrupts, or any of many other mechanisms for asynchronously invoking event-handling routines.

FIG. 16B shows a post-behavior event loop by which the currently described method implementation carries out monitoring, modeling, and estimation activities. The event loop shown in FIG. 16B operates continuously, periodically, or intermittently. In step 1608, the post-behavior event loop waits for a next post-behavior event to occur. When a next event occurs, then, as determined in step 1610, when the event is a post-data event, the routine “post data” is called, in step 1612. Otherwise, when the event is a page-evaluation event, as determined in step 1614, then the routine “page evaluation” is called in step 1616. When the event is a network-characterization event, as determined in step 1618, then the routine “network characterization” is called in step 1620. Otherwise, when the event is a post-evaluation event, as determined in step 1622, then the routine “post evaluation” is called in step 1624. Generally, an event loop may have many additional types of events, such as error-related events, maintenance events, power-up and power-down events, and other such events represented in FIG. 16B by ellipses 1625. A final default handler 1626 is shown to handle expected events or rare events associated with specific event-handling routines.

FIG. 16C provides a control-flow diagram for the routine “post data” called in step 1612 of FIG. 16B. A post-data event occurs when the organization first creates a post or posts the post to an organization-associated page as well as at various intervals in time by which the propagation behavior of the post is monitored by the currently described method. The routine “post data” initially determines, in step 1627, whether the post-data event that triggered invocation of the routine is an initial post-data event for a post or a monitoring event for the post. In the former case, in step 1628, the routine “post data” assigns an ID to the post, creates a data-point-collection data store to store propagation data points for the post, and evaluates and assigns certain attributes with respect to the post, as, for example, the page position, subject-matter category, content type, and other such attributes that can be initially determined. In the case of a monitoring event, the routine “post data” looks up the ID for the post in step 1629 and uses the ID to identify the data-point-collection data store and attribute values associated with the post. In step 1630, the routine “post data” determines the number of interest events associated with the post at the current time. Then, in step 1631, the routine “post data” enters a data point into the data-point-collection data store associated with the post that represents the determined number of interest events and the current time. In step 1632, the routine “post data” evaluates a window of recent data points for the post, which may include all of the data points for the post, in certain cases, to determine, in step 1633, whether the propagation of the post has reached the final steady-state level or value discussed above. When the steady-state value has been reached, as determined in step 1633, the routine “post data” uses the known page and post attributes related to the post, in step 1634, to select an appropriate data store and associated model for the post and then, in step 1635, adds the data points collected for the post to the selected data store. In step 1636, the data-point-collection data store is deallocated or deleted. Thus, when a steady-state behavior is reached for the post, the data collected for the post is added to the data associated with a particular model. The attributes associated with the post, with the page to which the post is posted, and social network attributes can be used, as discussed above, to select the most appropriate model and associated data store into which to add the data points. Note that data points may remain associated with various attribute values to facilitate subsequent data-point partitioning. Otherwise, when the steady state has not been reached, as determined in step 1633, the routine “post data” arranges for a subsequent post-data event in step 1637. Thus, the post-data event and the post-data routine represents a method for monitoring the propagation behavior of a post, in time, to accumulate post-propagation data points, based on which post-propagation models are determined and refined.

FIG. 16D provides a control-flow diagram for the routine “page evaluation” called in step 1616 of FIG. 1613. The routine “page evaluation” is called in response to a page-evaluation event, which is generally associated with creation of a new page by the client organization or by timers to provide for continuous, periodic, or intermittent monitoring of page-associated attributes. When the page-evaluation event that triggered the call to the routine “page evaluation” is an initial page-evaluation event for a newly created page, as determined in step 1640, then the routine “page evaluation” assigns an ID to the page, evaluates initial page attributes, and creates a data store and associated model for the page that best fits the page attributes, in step 1642. Otherwise, the routine “page evaluation” looks up the ID for the page in step 1644. In certain cases, IDs may be passed to routines in the event-occurrence mechanisms and, in other cases, the routine is able to identify the page with respect to which a page-evaluation event occurred and use this information to find the ID associated with the page. In the for-loop of steps 1646-1648, the routine “page evaluation” considers each data store and associated model for post propagation currently associated with the page and calls the routine “resolved” in step 1647, to potentially partition the data points of the model into data-point subsets associated with particular attribute values and attribute-value ranges, as discussed above with reference to FIGS. 12A-E. Then, in step 1649, the routine “page evaluation” re-evaluates any of the attribute values associated with the page based on current information obtained from the social network, the current set of page-propagation models associated with the page, current inferred attribute values, and other information. In step 1650, the routine “page evaluation” arranges for a subsequent page-evaluation event.

FIG. 16E illustrates how the initial data set associated with a page is resolved into multiple data sets associated with particular attribute values and attribute-value ranges. In FIG. 16E, the top rectangle 1652 represents an original data set associated with a newly created page. After some period of time, by applying various different combinations of attribute values to a data set to partition the data set into subsets, it may be determined that the original data set can be partitioned into subsets 1654-1656 using an attribute a. Data subset 1654 contains data points associated with values of attribute a greater than 10, data subset 1655 contains data points associated with values of attribute a in the range [2,10], and data subset 1656 contains data points associated with values of attribute a of less than 2. Similarly, following additional passage of time, by computing compactness metrics for various data subsets associated with various attribute-value combinations, data subset 1654 may be further divided into subsets 1657 and 1658 based on the value of an attribute b while data subset 1656 may be further divided into data subsets 1659 and 1660 based on the value of an attribute c. The current data sets are thus the leaf nodes in the graph shown in FIG. 16E. Each leaf-node data set is associated with a best-fitting model. Initially, as one example, the model may be a particular expression selected from a table of potential models, such as table 9B, with either unspecified parameter values or with broad ranges of values for the various parameters of the model, such as a, μ, and λ. Over time, the model is divided into subsets. The subsets may be associated with the same model expression but with narrower ranges of parameter values or exact parameter values or, in other cases, may be associated with alternate expressions or model types and associated parameter-value ranges.

FIG. 16F provides control-flow diagram for the routine “resolve” called in step 1647. In step 1662, the routine “resolve” sets a local variable diff to zero and a local variable attributeP to the null set. Then, in the for-loop of steps 1664-1670, the routine “resolve” is various different attribute-value partitioning of a data set subset and, when a partitioning is identified that produces a compactness-based metric better than any metric so far observed, the partitioning and the metric are stored in local variables attributeP and diff in step 1669. After considering the various attribute-value-based partitionings in the for-loop of steps 1664-1670, the routine “resolve” determines whether the diff value for the best-observed partitioning is greater than a threshold value, as determined in step 1672. When the diff value is greater than a threshold value, then the difference in compactness between the initial data set or data subset and the partitioned data subsets justifies dividing or partitioning the initial data set or subset into multiple lower-level data subsets, as discussed above with reference to FIG. 16E. This is done in step 1674. Finally, in step 1675, the routine “resolve” reconsiders each of the current leaf-node data sets stored in data stores associated with a current page and re-determines a best model that fits the data points in the data store. Thus, in step 1675, the routine “resolve” determines a best-fit model for each data set, either by selecting an expression and parameter-value ranges from a table of expressions such as that shown in FIG. 9B, by selecting another type of model and associated parameter-value ranges, or by refining the parameters associated with the model already associated with the data set.

FIG. 16G illustrates the routine “network characterization” called in step 1620 of FIG. 16B. This routine is called as a result of timer expiration or interrupts that allow the social-network-associated attributes maintained by the disclosed method to be periodically, intermittently, or continuously adjusted based on accumulated data and the current attribute values associated with the pages of an organization. A readjustment of the network attributes is carried out in step 1678 and, in step 1680, the routine “network characterization” arranges for a subsequent network-characterization event.

FIG. 16H provides a control-flow diagram for the routine “post evaluation” called in step 1624 of FIG. 16B. In step 1684, the routine “post evaluation” receives a post-evaluation request. This is generally a request from a client for the estimation of one or more characteristics or parameters of time-dependent post-propagation behavior for a provided post. In step 1686, the routine “post evaluation” looks up an ID for the post and accesses the data store and attribute values associated with the post. In step 1688, the routine “post evaluation” determines the page to which the post has been posted. In step 1690, based on the attribute values associated with the post, the attribute values associated with the page on which the post is posted, and with the attribute values associated with the social network, the routine “post evaluation” chooses a data store/model associated with the page on which the post is posted that best fits the post-associated, page-associated, and social-network-associated attributes. Then, in step 1692, the routine “post evaluation” uses the model and data store to estimate and return the requested post-propagation time-behavior characteristics and parameters. This may include the projected maximum number of interest events associated with the post, the size of the maximum-reached-audience of social-network participants the size of target-audience social-network participants, the maximum rate of post propagation, and other such parameters and characteristics or derived or inferred parameters and characteristics. Thus, the currently disclosed method is able to provide estimates of various characteristics and parameters of post propagation prior to posting of the post and during the initial interval time following posting of the post before a large number of data points are available.

Although the present invention has been described in terms of particular embodiments, it is not intended that the invention be limited to these embodiments. Modifications within the spirit of the invention will be apparent to those skilled in the art. For example, any of many different design and implementation parameters may be varied and alternatively selected in order to produce any of many different possible implementations of the post-propagation time-behavior characteristics and parameters estimation method discussed above. As discussed above, the method implementations may be incorporated into computers and data centers within an advertising organization, another type of commercial organization, a social network, or a third-party service provider that provides estimates of the time behavior of post propagation on behalf of commercial clients.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method that provides an estimate of time-dependent propagation of a target post, the method comprising:
storing, in one or more electronic data-storage devices, propagation data for multiple posts along with attribute values for post-associated attributes;
for each of one or more social-network pages, storing, in one or more electronic data-storage devices, propagation data for multiple posts posted to the social-network page in one or more data stores associated with the social-network page, each data store associated with a post-propagation model, along with attribute values for page-associated attributes;
receiving a request for the estimate of time-dependent propagation of the target post;
determining values of post-associated attributes for the target post;
determining values of post-associated attributes for a social network page associated with the target post;
using the determined post-associated attributes and page-associated attributes to select a post-descriptive post-propagation model from among the post-propagation models;
estimating the time-dependent propagation of the target post from the post-descriptive post-propagation model; and
storing the estimated time-dependent propagation of the target post in memory.

2. The method of claim 1 wherein the target posts and the multiple posts comprise information having a subject category, a content type, and other post-associated attributes that can be posted to a social-network page for distribution to social-network participants within a social network.

3. The method of claim 2 wherein, once posted, a post has additional post-associated attributes including a post identifier, a page identifier, a post date, a post time, a post age, position of the post on the social-network page identified by the page identifier, and a number of interest events associated with the post.

4. The method of claim 2 wherein each social-network page is associated with page-associated attributes including a subject-matter category, a number of direct links, a number of posts, a post rate, and a page identifier.

5. The method of claim 1 wherein propagation models include:
parameterized expressions for sigmoidal curves;
parameterized expressions for cumulative curves;
Markov models;
time-series models; and
program-generated models.

6. The method of claim 1 wherein storing, in one or more electronic data-storage devices, propagation data for multiple posts along with attribute values for post-associated attributes further includes:
when the already-stored propagation data for a post indicates that the post has reached a saturation point at which the propagation rate for the post falls below a threshold level, using values of post-associated attributes for the post and values of page-associated attributes for the social-network page to which the post was posted to select a data store and associated post-propagation model; and
adding the already-stored propagation data for the post to the selected data store.

7. The method of claim 1 wherein storing, in one or more electronic data-storage devices, propagation data for multiple posts posted to the social-network page in one or more data stores associated with the social-network page, each data store associated with a post-propagation model, along with attribute values for page-associated attributes further includes:
continuously, periodically, or intermittently resolving the propagation data stored in a data store into propagation-data subsets stored in multiple new data stores, fitting a propagation model to the new data stores and associated the fitted propagation model for each new data store with the data store, and re-evaluating page-associated attribute values for the social-network page.

8. The method of claim 1 wherein the social-network pages are provided by a social network which has values for various social-network-associated attributes, and wherein the values for various social-network-associated attributes are continuously, periodically, or intermittently evaluated based on page-associated attribute values for pages provided by the social network.

9. The method of claim 8 wherein the social-network-associated attributes are used, along with page-associated attribute values and post-associated attribute values, to select a post-descriptive post-propagation model from among the post-propagation models and are used, along with page-associated attribute values, to select a data store and associated post-propagation model.

10. The method of claim 1 wherein a post posted to a social-network page propagates directly to social-network participants directly linked to the social-network page and subsequently propagates to additional social-network participants as a result of interest events.

11. A system comprising:
one or more processors;
one or more data storage devices selected from electronic memories and mass-storage devices;
and computer instructions, stored in the one or more electronic memories, that control the system to provide an estimate of time-dependent propagation of a target post by
storing, in one or more electronic data-storage devices, propagation data for multiple posts along with attribute values for post-associated attributes,
for each of one or more social-network pages, storing, in one or more electronic data-storage devices, propagation data for multiple posts posted to the social-network page in one or more data stores associated with the social-network page, each data store associated with a post-propagation model, along with attribute values for page-associated attributes,
receiving a request for the estimate of time-dependent propagation of the target post,
determining values of post-associated attributes for the target post,
determining values of post-associated attributes for a social network page associated with the target post,
using the determined post-associated attributes and page-associated attributes to select a post-descriptive post-propagation model from among the post-propagation models,
estimating the time-dependent propagation of the target post from the post-descriptive post-propagation model, and
storing the estimated time-dependent propagation of the target post in memory.

12. The system of claim 11 wherein the target posts and the multiple posts comprise information having a subject category, a content type, and other post-associated attributes that can be posted to a social-network page for distribution to social-network participants within a social network.

13. The system of claim 12 wherein, once posted, a post has additional post-associated attributes including a post identifier, a page identifier, a post date, a post time, a post age, position of the post on the social-network page identified by the page identifier, and a number of interest events associated with the post.

14. The system of claim 12 wherein each social-network page is associated with page-associated attributes including a subject-matter category, a number of direct links, a number of posts, a post rate, and a page identifier.

15. The system of claim 11 wherein propagation models include:
parameterized expressions for sigmoidal curves;
parameterized expressions for cumulative curves;
Markov models;
time-series models; and
program-generated models.

16. The system of claim 11 wherein storing, in one or more electronic data-storage devices, propagation data for multiple posts along with attribute values for post-associated attributes further includes:
when the already-stored propagation data for a post indicates that the post has reached a saturation point at which the propagation rate for the post falls below a threshold level, using values of post-associated attributes for the post and values of page-associated attributes for the social-network page to which the post was posted to select a data store and associated post-propagation model; and
adding the already-stored propagation data for the post to the selected data store.

17. The system of claim 11 wherein storing, in one or more electronic data-storage devices, propagation data for multiple posts posted to the social-network page in one or more data stores associated with the social-network page, each data store associated with a post-propagation model, along with attribute values for page-associated attributes further includes:
continuously, periodically, or intermittently resolving the propagation data stored in a data store into propagation-data subsets stored in multiple new data stores, fitting a propagation model to the new data stores and associated the fitted propagation model for each new data store with the data store, and re-evaluating page-associated attribute values for the social-network page.

18. The system of claim 11 wherein the social-network pages are provided by a social network which has values for various social-network-associated attributes, and wherein the values for various social-network-associated attributes are continuously, periodically, or intermittently evaluated based on page-associated attribute values for pages provided by the social network.

19. The system of claim 18 wherein the social-network-associated attributes are used, along with page-associated attribute values and post-associated attribute values, to select a post-descriptive post-propagation model from among the post-propagation models and are used, along with page-associated attribute values, to select a data store and associated post-propagation model.

20. The system of claim 11 wherein a post posted to a social-network page propagates directly to social-network participants directly linked to the social-network page and subsequently propagates to additional social-network participants as a result of interest events.
